(19) United States
(12) Patent Application Publication
(10) Pub. No.: US 2024/0299943 A1
(43) Pub. Date: Sep. 12, 2024

(54) MICROFLUIDIC DEVICES AND RAPID PROCESSING THEREOF

(71) Applicant: HueDx, Inc., Philadelphia, PA (US)

(72) Inventors: Brianna Wronko, Philadelphia, PA (US); Samuel Parks, Philadelphia, PA (US); Nidhi Menon, Philadelphia, PA (US); Brittany Auyoung, Philadelphia, PA (US); Prava Sharma, Philadelphia, PA (US); Rohan Vemu, Philadelphia, PA (US); David Beery, Philadelphia, PA (US)

(21) Appl. No.: 18/597,473

(22) Filed: Mar. 6, 2024

Related U.S. Application Data
(60) Provisional application No. 63/488,854, filed on Mar. 7, 2023.
(60) Provisional application No. 63/578,215, filed on Aug. 23, 2023.
(60) Provisional application No. 63/599,740, filed on Nov. 16, 2023.

(51) Int. Cl. B01L 3/00; G06T 7/00; G06T 7/73; G06T 7/90; H04N 23/60

(52) U.S. Cl. CPC B01L 3/502761; G06T 7/0012; G06T 7/73; G06T 7/90; B01L 2200/025; B01L 2300/021; B01L 2300/0681; B01L 2300/0825; B01L 2300/126; G06T 2200/24; G06T 2207/10024; G06T 2207/20081; G06T 2207/30024; G06T 2207/30204; G06T 2207/30244; H04N 23/64

(57) ABSTRACT

The disclosure relates to a paper based microfluidic diagnostic device, which may include a top panel comprising a first plurality of cut regions and a bottom panel comprising a second plurality of cut regions, wherein the first and second plurality of cut regions are configured to form a plurality diagnostic wells, each of the diagnostic wells comprises a diagnostic paper layer positioned over a filter paper layer, the diagnostic paper layer comprises one or more diagnostic components for quantitative assessment of an analyte, and at least one of the top panel or the bottom panel comprises a plurality of image registration markers included on the top panel and a plurality of image calibration markers.

### PRIORITY AND CROSS-REFERENCE TO RELATED APPLICATIONS

This application claims priority to U.S. Provisional Application No. 63/488,854 filed Mar. 7, 2023 entitled MICROFLUIDIC DEVICES AND RAPID PROCESSING THEREOF; U.S. Provisional Application No. 63/578,215 filed Aug. 23, 2023, entitled “MICROFLUIDIC DEVICES AND METHODS OF USE THEREOF”; and U.S. Provisional Application No. 63/599,740 filed Nov. 16, 2023, entitled “MICROFLUIDIC DEVICES AND METHODS OF USE THEREOF”, the entire disclosures of each of the applications being incorporated herein by reference.

### FIELD

The present disclosure generally relates to paper microfluidic devices and quantification of target analytes using image analysis.

### BACKGROUND

Paper based microfluidic analytical devices have emerged in recent years, leading to development of a number of inexpensive and quick point-of-collection (“POC”) analyses, including HIV chips, paper ELISA, and other low-cost colorimetric diagnostic assays. Such paper based microfluidic assays are gaining popularity as a simple and fast way for analyte detection in human biological specimen (for disease screening), chemical compound or component detection in soil samples, quality control in food processing and agriculture, diagnostic screening in industrial applications, or the like. POC diagnostics are advantageous in many resource-limited settings where healthcare, transportation, and distribution infrastructure may be underdeveloped or underfunded. A main advantage of a POC diagnostic is the ability to perform the above diagnostics without the support of a laboratory infrastructure. This increases access, removes the need for sample transport, and substantially reduces the time it takes to obtain diagnostic results providing cost-effective and convenient diagnostics. Accordingly, in the healthcare settings, more patients are effectively diagnosed and assessed, enabling more efficient and effective healthcare treatment. Although paper-based diagnostics have been known and used for several years, many paper POC devices lack sufficient accuracy, quantitative readouts, or are economically infeasible due to various factors such as poor limits of detection, manufacturing difficulties, high non-specific adsorption, unstable reagents, long analysis time, complex user-technology interface, onerous detection method, and poor sensitivity, among others.

Although the colorimetric results of these assays can be viewed by naked eye, it is difficult to precisely quantify the analyte amount. Promising colorimetric detection results have been demonstrated using video cameras, digital color analyzers, scanners or custom portable readers. A key drawback of all these methods is the need for specialized instrumentation and for image analysis with a computer.

Thus, there is a need for an improved POC device that is sensitive, robust, readily manufactured at relatively low cost, easy to use, and that can be rapidly assessed to provide accurate, quantifiable results without the need for a laboratory infrastructure across various industries and use cases.

### SUMMARY

In a first scenario, the present disclosure generally relates to a paper based microfluidic diagnostic device. The microfluidic device may include a top panel including a first plurality of cut regions and a bottom panel including a second plurality of cut regions. The first and second plurality of cut regions may be configured to form a plurality diagnostic wells. Each of the diagnostic wells may include a diagnostic paper layer positioned over a filter paper layer, and the diagnostic paper layer may include one or more diagnostic components for quantitative assessment of an analyte. The top panel and/or the bottom panel may include a plurality of image registration markers included on the top panel and a plurality of image calibration markers.

In various implementations, each of the plurality of diagnostic wells may be configured to receive a fluid sample from a side of the bottom panel such that the fluid sample flow vertically to the diagnostic paper layer via the filter paper layer.

In various implementations, the diagnostic paper can be a single layer sheet of hydrophilic porous paper. Optionally, the diagnostic paper may be filter paper and/or chromatography paper.

In various implementations, the one or more diagnostic components may include, for example, reagents, dyes, probes, stabilizers, catalysts, anti-coagulants, lysing agents, nanoparticles, diluents, and/or combinations thereof. Optionally, the diagnostic component may be capable of selectively associating with the analyte selected from aspartate transaminase, alkaline phosphatase, alanine aminotransferase, bilirubin, albumin, total serum protein, glucose, cholesterol, creatine, sodium, calcium, gamma glutamyl transferase, direct bilirubin, indirect bilirubin, unconjugated bilirubin, and lactate dehydrogenase, glucose, blood urea nitrogen, calcium, bicarbonate, chloride, creatinine, potassium, hematocrit and sodium.

In some implementations, the paper based microfluidic diagnostic device may also include an identifying marker such as, for example, a QR code, a barcode, etc.

In some implementations, the plurality of image registration markers may include an ArUco marker. Optionally, at least some of the plurality of image registration markers may be provided at one or more corners of the top panel.

In some implementations, the plurality of image calibration markers may include a plurality of reference color markers. Optionally, the plurality of image calibration markers may include 24 unique colors. Additionally and/or alternatively, each of the 24 unique colors can be included in at least two of the plurality of image calibration markers.

In some implementations, the top panel may include the plurality of image registration markers and the plurality of image calibration markers.

Optionally, at least one slot for receiving a lateral flow reaction substrate may be included in the paper based microfluidic diagnostic device.

In another scenario, methods for detecting and quantifying analytes may include (a) obtaining a fluid sample; (b) depositing the fluid sample onto a microfluidic diagnostic device comprising one or more diagnostic wells. Each of the diagnostic wells can include: (i) a diagnostic paper layer that includes one or more diagnostic components provided thereon, and (ii) a filter paper later. The methods may further include: (c) capturing, using an image capture device, an image of a reacted microfluidic diagnostic device; (d) identifying, based on image registration markers included in the image, a region corresponding to a reacted diagnostic well; (e) normalizing, based on image calibration markers included in the image, a color of the region corresponding to the reacted diagnostic well; and (f) analyzing, using a machine learning model, the normalized color to predict a diagnostic test result. Optionally, the fluid sample is a biological fluid sample.

In some implementations, identifying the region corresponding to the reacted diagnostic well may include identifying one or more image registration markers in the image, determining a pose of the image capture device based on the image registration markers, using the pose of the image capture device to align the image with a template image corresponding to the diagnostic device, and identifying the region corresponding to the reacted diagnostic well based on a location of a diagnostic well in the template image. Optionally, identifying the template image corresponding to the diagnostic device based on an identification marker included in the image.

Optionally, the image registration markers may include ArUco markers.

In various implementations, normalizing the color of the region corresponding to the reacted diagnostic well may include performing a masking operation and a color transformation. The color transformation operation may include performing white balancing of the image. The white balancing may be performed by comparing an observed color value of a white colored image calibration marker to a known color value of the white colored image calibration marker. The color transformation may include generating a global transformation function for transforming the image to a first normalized image. Optionally, the global transformation function may be generated using multivariate gaussian distribution. The color transformation may further include reducing a dimensionality of the first normalized image to generate a reduced dimensionality image (e.g., using histogram mapping). The color transformation may further include transforming the reduced dimensionality image to the normalized image using multivariate gaussian distribution. In various embodiments, the masking operation may be performed the color transformation and may include masking the region corresponding to the reacted diagnostic well.

Optionally, the methods may also include identifying the machine learning model based on an identification marker included in the image.

In some implementations, the image capture device may be included in a mobile device and a graphical user interface (GUI) is displayed at the mobile device. Optionally, the methods may include generating a frame on the GUI to assist a use in proper positioning of the mobile device with respect to the diagnostic device during the capturing of the image.

The present disclosure also relates to, in some scenarios, selecting a machine learning model for predicting, based on an image, diagnostic test results by receiving an input data set and performance criteria; generating, from the input data set, a feature data set; using the feature dataset to train and evaluate a plurality of machine learning models; and selecting, based on the evaluation, a set of candidate machine learning models. An electronic device is disclosed that may include one or more processors, and one or more machine-readable media having instructions stored thereon that, when executed by the one or more processors, cause the electronic device to perform the methods.

In various implementations, the input data set can include input data and inference data corresponding to the input data. The performance criteria may include real-world performance expectations for the machine learning model. Optionally, the performance criteria may include at least one of the following for the machine learning model: accuracy, precision, coefficient of variation, limit of detection or limit of quantification.

In various implementations, using the input dataset to train and evaluate the plurality of machine learning models may include generating a feature data set for training and evaluating the plurality of machine learning models from the input data set.

In various implementations, selecting the set of candidate machine learning models may include selecting each of the plurality of machine learning models that have a performance characteristic greater than a threshold.

In various implementations, the methods may further include using Bayesian optimization for tuning one or more hyperparameters of each of the set of candidate machine learning models. Optionally, the methods may include selecting a highest performing machine learning model from the set of machine learning models as the machine learning model for predicting, based on the image, the diagnostic test results. Additionally, the methods may include training the machine learning model.

The present disclosure, in various other scenarios, also relates to a method for designing diagnostic assays. The method may include receiving a plurality of experimental designs corresponding to a plurality of assays and associated results; modeling, using a Gaussian process, a mean and an uncertainty associated with the plurality of experimental designs; generating a recommended experimental design that maximizes the mean and minimizes the uncertainty; receiving a result corresponding to an execution of the recommended experimental design; determining whether the result meets a performance criteria; and repeating the modeling, generating, and receiving steps, based on the plurality of experimental designs and the recommended experimental design, in response to determining that the result does not meet the performance criteria. An electronic device is disclosed that may include one or more processors, and one or more machine-readable media having instructions stored thereon that, when executed by the one or more processors, cause the electronic device to perform the methods.

In various implementations, the result may be determined to meet the performance criteria if a grade of the recommended experimental design is maximized.

Optionally, the result may be determined to meet the performance criteria if a variable design space including the plurality of experimental designs is optimized.

In certain scenarios, the present disclosure describes a microfluidic diagnostic device including a top panel comprising a first plurality of cut regions, and a bottom panel comprising a second plurality of cut regions. Optionally, the first and second plurality of cut regions may be configured to form a plurality of receptacles that are each configured to receive a lateral flow test strip, and at least one of the top panel or the bottom panel may include a plurality of image registration markers included on the top panel and a plurality of image calibration markers.

Optionally, each of the plurality of receptacles may be configured to position one or more analyte capture zones in the test strip in such that an image capture device can capture an image of the one or more analyte capture zones in association with one or more image registration markers and the plurality of image calibration markers.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated herein and constitute part of this specification, are illustrative of particular embodiments of the present disclosure and do not limit the scope of the present disclosure. The drawings are not to scale and are intended for use in conjunction with the explanations in the following detailed description.

FIG. 1 illustrates an example computing system in accordance with the present disclosure.

FIG. 2A shows a perspective view of a diagnostic device; and FIG. 2B shows an exploded view of the diagnostic device shown in FIG. 2A.

FIG. 2C illustrates another example diagnostic device including a lateral flow test strip; FIG. 2D shows another example diagnostic device including a lateral flow test strip; FIG. 2E shows another example diagnostic device including a lateral flow test strip

FIG. 3 illustrates an example process for predicting diagnostic test results by analyzing an image of a diagnostic test.

FIG. 4A illustrates an example image after a masking operation; FIG. 4B illustrates another example image after a masking operation; FIG. 4C illustrates an example image after a color transformation; FIG. 4D illustrates another example image after a color transformation; and FIG. 4E illustrates an example graphical user interface (GUI) for displaying predicted diagnostic test results.

FIG. 5 illustrates an example process for selecting a machine learning model for predicting results of a diagnostic test.

FIG. 6 illustrates a prior art experimental design.

FIG. 7 illustrates an example process for experimental design optimization for creating diagnostic test assays.

FIG. 8A illustrates and example experimental design created during one or more steps of FIG. 7.

FIG. 8B illustrates and example experimental design created during one or more steps of FIG. 7.

FIG. 9 illustrates alignment of an image capture device with respect to a diagnostic device.

FIG. 10 shows an example of a computing and networking environment in accordance with the present disclosure.

### DETAILED DESCRIPTION

The following discussion omits or only briefly describes features of the disclosed technology that are apparent to those skilled in the art. It is noted that various embodiments are described in detail with reference to the drawings, in which like reference numerals represent like parts and assemblies throughout the several views. In drawings that depict multiple like components (e.g., multiple diagnostic chambers), a single representative component may be identified by the appropriate reference numeral. Reference to various embodiments does not limit the scope of the claims appended hereto. Additionally, any examples set forth in this specification are intended to be non-limiting and merely set forth some of the many possible embodiments for the appended claims. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “comprises” and/or “comprising,” when used in this specification, specify the presence of stated features, elements, and/or components, but do not preclude the presence or addition of one or more other features, steps, operations, elements, components, and/or groups thereof.

The term ‘diagnostic device’ as may be used herein means a reusable or disposable medium capable of receiving a target sample and having the appropriate chemistry to enable the embodied colorimetric reaction. The diagnostic device may be used across a diverse spectrum of industries such as, without limitation, healthcare, agriculture, manufacturing, food processing, or the like, where sample transport or required laboratory facilities prevent the effective use of certain already-known assay-based diagnostic tests.

The term ‘colorimetric test,’ or ‘colorimetry’ based assay as may be used herein means at least a measurable color change from one color to a different color or a measurable change in intensity of a particular color, in the presence of the analyte.

The term ‘rapid’ as may be used herein means ‘essentially in real time’ (e.g., seconds, minutes).

The term ‘point-of-collection’ as may be used herein means making a rapid target measurement at the time a sample is collected on a modular diagnostic test platform (e.g., test strip) in possession of the user and then inserted into the embodied smartphone system, not at a later time, for example, after a sample has been collected and sent to a laboratory.

As used herein, a “computing device” refers to a device that includes a processor and memory. Each device may have its own processor and/or memory, or the processor and/or memory may be shared with other devices as in a virtual machine or container or network arrangement. The memory will contain or receive programming instructions that, when executed by the processor, cause the electronic device to perform one or more operations according to the programming instructions.

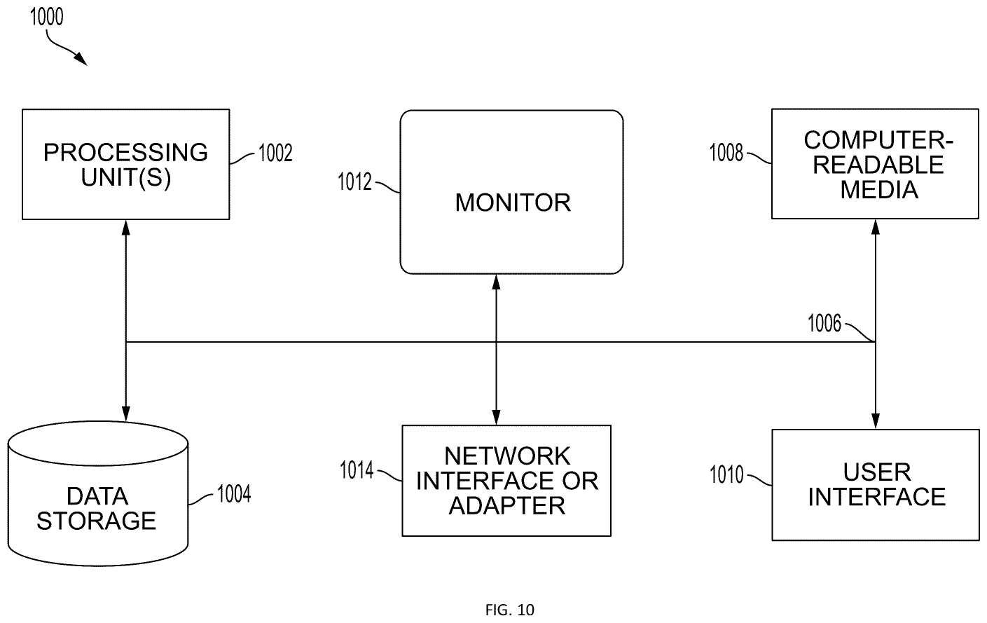

As used herein, the terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices. As used in this description, a “computing device” or “electronic device” may be a single device, or any number of devices having one or more processors that communicate with each other and share data and/or instructions. Examples of electronic devices include personal computers, servers, mainframes, virtual machines, containers, digital home assistants, and mobile electronic devices (or mobile devices) such as smartphones, fitness tracking devices, wearable virtual reality devices, Internet-connected wearables such as smart watches and smart eyewear, personal digital assistants, cameras, tablet computers, laptop computers, media players and the like. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 10.

As used herein, the terms “processor” and “processing device” each refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process. A computer program product is a memory device with programming instructions stored on it.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices. The network may include or is configured to include any now or hereafter known communication networks such as, without limitation, a BLUETOOTH® communication network, a Z-Wave® communication network, a wireless fidelity (Wi-Fi) communication network, a ZigBee communication network, a HomePlug communication network, a Power-line Communication (PLC) communication network, a message queue telemetry transport (MQTT) communication network, a MTConnect communication network, a cellular network a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. As such, network 204 may be configured to implement wireless or wired communication through cellular networks, WiFi, BlueTooth, Zigbee, RFID, BlueTooth low energy, NFC, IEEE 802.11, IEEE 802.15, IEEE 802.16, Z-Wave, Home Plug, global system for mobile (GSM), general packet radio service (GPRS), enhanced data rates for GSM evolution (EDGE), code division multiple access (CDMA), universal mobile telecommunications system (UMTS), long-term evolution (LTE), LTE-advanced (LTE-A), MQTT, MTConnect, CoAP, REST API, XMPP, or another suitable wired and/or wireless communication method. The network may include one or more switches and/or routers, including wireless routers that connect the wireless communication channels with other wired networks (e.g., the Internet). The data communicated in the network may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, MTConnect protocol, or any other protocol.

A central theme in analyte detection or diagnostics is the ability to detect analytes at the POC (for, for example, chemical compound or component detection in soil samples, quality control in food processing and agriculture, analyte detections or diagnostics in industrial applications, diagnostic screening for veterinarian purposes). For example, for diagnosing one or more medical conditions at the point of care. The human body presents various bodily fluids which can be accessible in a non-invasive manner such as, for example, breath, saliva, tears, mucus, etc. which can contain key biomarkers or analytes for providing an accurate analysis of a medical condition. For example, biomarkers such as glucose, alcohol, cancer biomarkers, biomarkers of stress, pregnancy, endocrinological diseases, polycystic ovary syndrome (PCOS) or other infertility diagnoses, neurological diseases (e.g., Cushing's disease, Addison's diseases, Alzhiemers, multiple schlerosis (MS), post-traumatic stress disorder (PTSD), Parkinson's disease, etc.), metabolic diseases, osteoporosis, and other diseases can present themselves in bodily fluids.

The present disclosure relates to POC microfluidic devices and methods of use thereof for testing of a fluid sample—e.g., a biological fluid sample obtained from a subject (e.g., blood, urine, saliva, nasal secretions, etc.), such as a human or other mammal; or another type of fluid sample, such as a water sample, prepared solution, non-biological sample, and the like. The devices are designed to be usable without the need for a laboratory infrastructure—e.g., in a home, in a mobile unit, or in an out-patient clinical setting, such as a physician's office. In some embodiments, use of the microfluidic device involves depositing a fluid sample onto the device so that the sample flows to a diagnostic paper where the sample chemically reacts with a diagnostic component, resulting in a color change and/or a change in color intensity that can be quantified and recorded by taking an image of the colorimetric test, and an application running on a mobile device for image analysis.

Furthermore, it would be desirable to use lower-cost devices such as smartphones for interpreting these color-based test results. However, the cameras in smartphones do not always have the greatest color accuracy, and are generally not calibrated lighting conditions. The systems and methods may, for example, be used to analyze results of rapid diagnostic tests that provide a visual colorimetric indication of test results (e.g., appearance of a line, color change, change in color intensity etc.) due to the presence of a certain chemical response associated with a medical condition. The systems and methods described herein utilize novel image analysis techniques to automatically interpret results of a diagnostic test that enable easy, accurate, and reliable performance of the diagnostic test from a variety of settings, including in the home or outside of traditional healthcare settings, while compensating for differences in lighting conditions during image acquisition under uncontrolled lighting conditions (e.g., outside of laboratory or healthcare settings).

The computing devices described herein are non-conventional systems at least because of the use of non-conventional component parts and/or the use of non-conventional algorithms, processes, and methods embodied, at least partially, in the programming instructions stored and/or executed by the computing devices. For example, exemplary embodiments may use configurations of and processes involving a unique microfluidic device as described herein, unique processes and algorithms for image analysis for detection and extraction of regions of interest of the panels for analysis, color normalization, machine modeling to determine diagnostic results, selection and training of machine learning models, experimental design of an analyte assay, or combinations thereof. The systems and methods described herein also include POC diagnostics that are unique from conventional systems and methods, even as compared to those diagnostic devices used within laboratory settings. Exemplary embodiments may be used to effectively diagnose and assess patients at the point of care or collection, within a shortened turnaround time, without transporting the fluid samples large distances, enabling more efficient and effective healthcare treatment. The systems and methods described herein include paper-based diagnostics that may be unique in providing sufficient accuracy and/or are economically feasible. Exemplary embodiments described herein include systems and methods of an improved paper-based POC device that is sensitive, robust, readily manufactured at relatively low cost, easy to use, and that can be rapidly assessed to provide accurate, quantifiable results without the need for a laboratory infrastructure. The systems and methods described herein include unique and beneficial image processing techniques and algorithms that permit the diagnostic system to be used with any frame or microfluidic device shape according to embodiments described herein without preprograming or entry of the microfluidic shape into the system before detection and diagnostic. Although exemplary benefits are provided herein, a person of skill in the art would appreciate that any combination of the benefits provided may be realized without departing from the full scope of the disclosure. Therefore, no single benefit, component, or attribute is necessary to the practice of the disclosure.

Generally, a broad array of machine learning algorithms are available, with new algorithms the subject of active research. For example, artificial neural networks, learned decision trees, and support vector machines are different classes of algorithms which may be applied to classification problems. And, each of these examples may be tailored by choosing specific parameters such as learning rate (for artificial neural networks), number of trees (for ensembles of learned decision trees), and kernel type (for support vector machines). The large number of machine learning options available to address a problem makes it difficult to choose the best option or even a well-performing option. The amount, type, and quality of data affect the accuracy and stability of training and the resultant trained models. Further, problem-specific considerations, such as tolerance of errors (e.g., false positives, false negatives) scalability, and execution speed, limit the acceptable choices. This disclosure further describes systems and methods for selection of appropriate machine learning model(s) for performing image analysis and predicting tests results of a particular diagnostic test. The disclosure describes comparison of candidate machine learning models to calculate and/or to estimate the performance of one or more machine learning algorithms configured with one or more specific parameters (also referred to as hyper-parameters) with respect to a given set of data. The disclosure further describes a Bayesian optimization based approach for selection of the best model and/or model hyperparameters that results in the highest level of model performance for predicting diagnostic test results.

This disclosure also describes systems and methods for faster and more reliable experimental design of one or more analyte assays to be included on a diagnostic device using a machine learning approach including Bayesian optimization. The experimental design methods described herein are configured to handle constraints, high dimensionality, mixed variable types, multiple objectives, parallel (batch) evaluation, and the transfer of prior knowledge.

Accordingly, the systems and methods described herein may enable diagnostic information to be quickly and easily obtained and communicated to provide insight on the medical condition of a user, which may in turn prompt suitable follow-up actions for medical care such as prescribing medication, providing medical guidance or treatment, etc.

Although the systems and methods are primarily described herein with respect to analysis of medical diagnostic tests, it should be understood that in some variations, the systems and methods may be used in other applications outside of healthcare, such as in analysis of testing of food, drink, environmental conditions, sample purity, vet applications etc. It should also be noted that while the disclosure describes paper based microfluidic devices and platforms, the systems and methods of the current disclosure may be used for performing diagnostics (and other applications) on other suitable platforms such as microtiter plates, or the like.

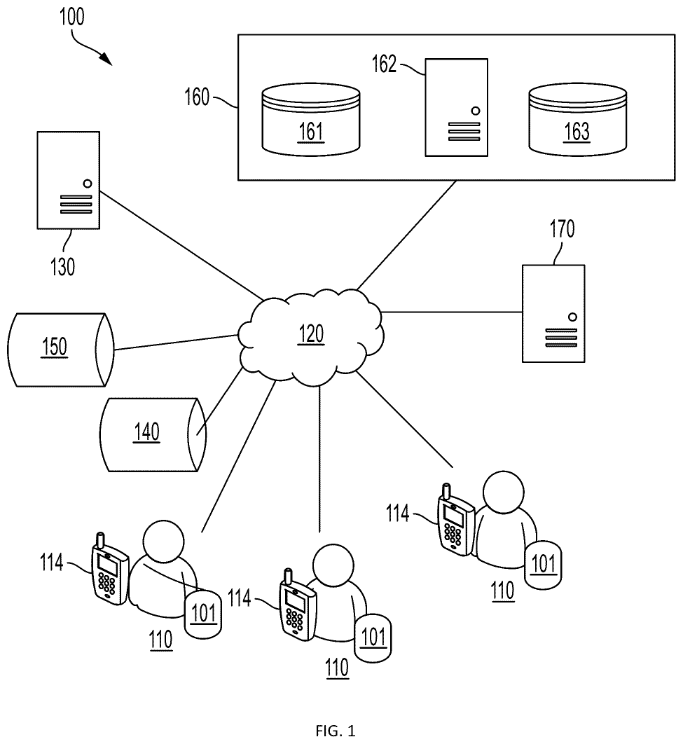

Generally, FIG. 1 illustrates a computing system 100 in accordance with the current disclosure. As shown in FIG. 1, diagnostic devices 101 (including one or more diagnostic tests or assays) may be used by one or more users 110 for performing diagnostic tests. Each user 110 may initiate and perform a diagnostic test (e.g., by applying a sample such as urine, saliva and buffer, nasal swab and buffer, or blood and buffer to the diagnostic device), then obtain at least one image of the diagnostic test such as with a mobile device 114 having at least one image sensor (e.g., smartphone, tablet, etc.). The mobile device 114 may communicate the image of the diagnostic device via a network 120 (e.g., cellular network, Internet, etc.) to a predictive analysis system 130 which may include one or more processors configured to utilize image analysis techniques to interpret test results from the image of the diagnostic test. Additionally or alternatively, at least a portion of the predictive analysis system 130 may be hosted locally on the mobile device 114. In some variations, the mobile device 114 may execute a mobile application which may provide a graphical user interface (GUI) to guide a user through obtaining and/or applying a sample to the diagnostic test, and/or guide a user through obtaining a suitable image of the diagnostic test for analysis.

Example techniques for analyzing the image(s) of the diagnostic test are described in further detail below. For example, the predictive analysis system 130 may utilize one or more features in a diagnostic device that support the image analysis-based interpretation of diagnostic tests, as further described below. The predicted test results may then be communicated to the user (e.g., via the mobile device 114, such as through a GUI on an associated mobile application), to another suitable user (e.g., medical care practitioner), to an electronic health record 140 associated with the user, other storage device(s), and/or other suitable entity.

In various implementations, the predictive analysis system 130 may be in communication with a data store 150 and a modeling system 160 via the network 120. The data store 150 may include one or more database(s) to store, for example, a configuration file including information relating to the diagnostic devices, user information, trained machine learning models, assay designs for diagnostic device production, or the like. The modeling system 160 may include a model library 161 configured for storing machine learning algorithms and corresponding parameters, one or more processors 162 configured to select and train machine learning models for interpreting results, based on image analysis, for diagnostic tests, and a trained model repository 163 for storing trained models.

The computing environment 100 may also include an experimental design system 170 which may include one or more processors configured to generate analyte assay designs for production of one or more diagnostic devices 101.

### Diagnostic Device Including a Microfluidic Device

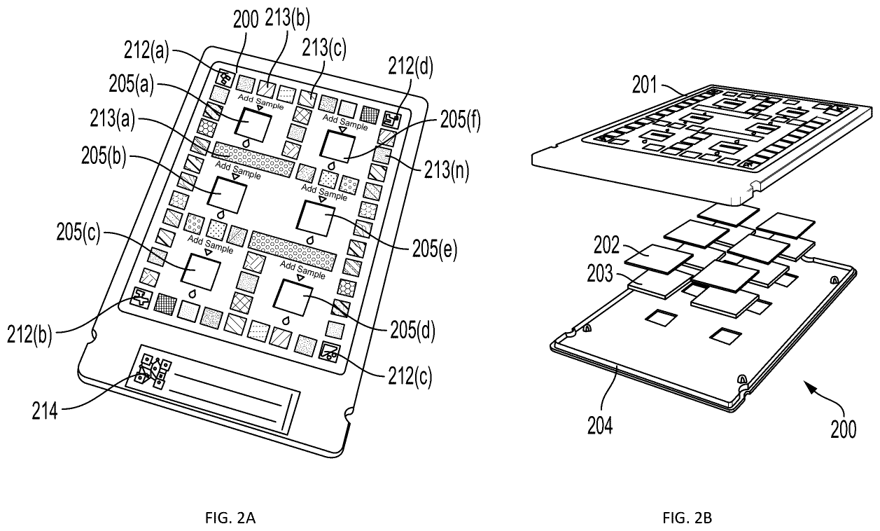

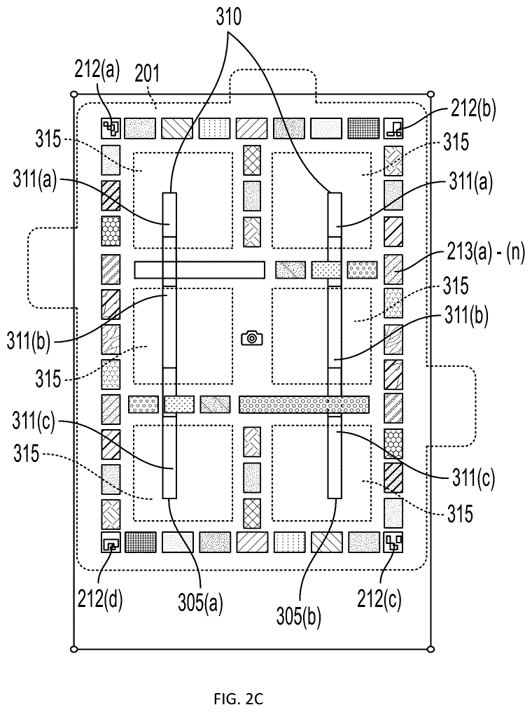

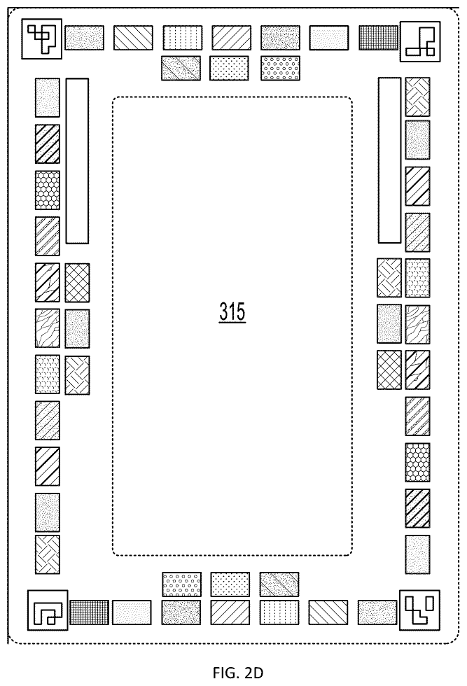

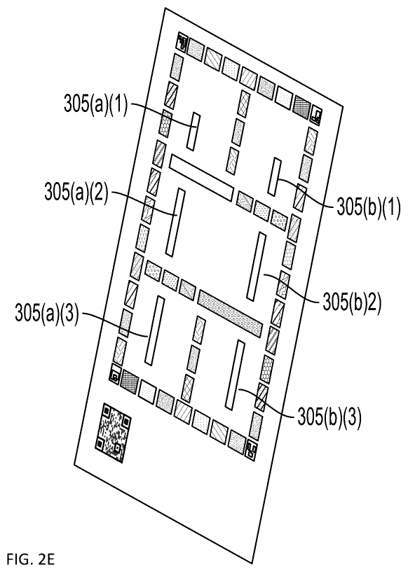

Referring now to FIGS. 2A and 2B, an example diagnostic device 200 including a microfluidic device is described. It should be noted, however, that the systems and methods of the current disclosure can be used with any now or hereafter known diagnostic devices such as, for example, the devices disclosed in WO2022159570. Other examples of diagnostic devices may include, without limitation, rapid diagnostic tests that depict a visual indication of a test result, such as a line, color change, pattern, or other fiducial (e.g., test strips, dipstick tests, or the like).

As shown in FIGS. 2A and 2B, the diagnostic device 200 includes a diagnostic paper layer 202 stacked over a filter paper layer 203, and sandwiched between a top panel 201 and a bottom panel 204. The top panel 201 and the bottom panel 204 are configured to be attached in, for example, a hinged press-fit design (however other attachments are within the scope of this disclosure). Each of the top panel 201 and the bottom panel 204 includes one or more cut portions that are aligned with each other within the diagnostic device 200 to form diagnostic wells 205(a)-(f) (collectively, 205) that each include at least a portion of the diagnostic paper layer 202 stacked over at least a portion of the filter paper layer 203. The cut portions in the top panel 201 and the bottom panel 204 may be configured to include indents or other shapes that form a perimeter or boundary around each diagnostic well. While FIGS. 2A-2D illustrate six (6) similarly shaped and sized wells, the disclosure is not so limiting and any number (e.g., 1, 2, 3, 4, 5, 6, 7, 8, and so on), shape (e.g., square, rectangle, triangle, oval, etc.), and size of diagnostic wells may be included in the diagnostic device. Furthermore, the diagnostic wells may be similar or different from each other, and arranged in any suitable configuration. The hinged press-fit design and personalized indents for each diagnostic well are carefully designed to maximize surface contact between the diagnostic paper layer and the filter paper layer, prevent sample or reagent run-off/leakage, as well as for ease of assembly. This ensures consistent pressure-driven vertical flow of the biological sample to the diagnostic paper layer via the filter paper layer. Optionally, the filter paper and diagnostic paper combination may be encased at least partially in a plastic lamination (not shown here).

It should be noted that while the figures illustrate a diagnostic paper layer that includes unconnected portions of the diagnostic paper disposed within each of the wells, and that are unconnected in the spacing between the wells, one or more of the wells may include connected pieces of diagnostic paper layer that form one or more continuous connections with in the spacing between the walls. It should also be noted that while the figures illustrate a single filter paper layer that includes unconnected portions of the diagnostic paper disposed within each of the wells, and that are unconnected in the spacing between the wells, one or more of the wells may include connected pieces of diagnostic paper layer that form one or more continuous connections with in the spacing between the walls. Optionally, an adhesive may be used between different layers of filter paper, different layers of diagnostic paper, and/or between a diagnostic paper layer and a filter paper layer.

In certain implementations, a fluid sample to be tested is applied into the diagnostic wells from the bottom panel side 204 such that it vertically flows through the filter paper layer 203 to the diagnostic paper layer 202 to create a visual indication of the test being performed. The visual indication may be imaged from the side of the top panel 201 (along with various fiducial markers included on the top panel 201 that aid in image analysis, as discussed below). This allows for imaging of the visual indication while minimizing any artifacts that may be created by filtering of the fluid sample by the filter paper layer (e.g., red blood cells, hematocrit, white blood cells, etc. filtered from whole blood). Optionally, the filtered components may be quantified using one or more embodiments of this disclosure.

In various embodiments, the diagnostic paper is a single layer sheet of hydrophilic, porous paper. In one embodiment, the diagnostic paper is filter paper or chromatography paper. In some embodiments, the diagnostic paper is formed from a single material. In some embodiments, the diagnostic paper includes or excludes one or more materials selected from nitrocellulose, cellulose acetate, polymer film, cloth, glass (e.g., borosilicate glass microfiber), cotton-linter microfibre, glass-microfibre, polypropylene melt blown fiber, polysulfone membranes, derivatives of them and/or combinations of them. Other non-limiting examples of suitable diagnostic papers include the following grades: Grade B, Grade B-85, Grade F, Grade C, Grade RG, Grade LL-72, Grade D-23, Grade D-23-TC-1, Grade Fibrous Cellulose Acetate, Grade WT-2500hpc, Grade CFP1, Grade CFP2, Grade CFP 1654, Grade BLOTT, and Grade WT-CFP-PE1. The type of diagnostic paper in one diagnostic well may be the same as or different from the type of diagnostic paper in one or more other diagnostic wells.

Further, one or more diagnostic components are provided within each diagnostic well 205 on the corresponding diagnostic paper 202. In some embodiments, the diagnostic components are printed onto the paper. In other embodiments, the diagnostic components are otherwise deposited onto the paper. Non-limiting examples of suitable diagnostic components include: reagents, dyes, probes, stabilizers, catalysts, anti-coagulants (e.g., EDTA or heparin), colorimetric probes, fluorescent probes, lysing agents, nanoparticles, diluents, and combinations thereof. In some embodiments, each diagnostic paper contains one, two, or three diagnostic components. For example, a mixture containing a dye and a reagent that selectively associates with a target analyte may be deposited onto a diagnostic paper. Additionally, the paper may be soaked in a variety of chemicals, stabilizers, or pH modifying solutions that enable the reaction to occur at a stable pH. Alternatively, a mixture containing a dye, a stabilizer, and a reagent that selectively associates with a target analyte may be deposited onto a diagnostic paper. Other combinations are contemplated as well, based on the target analyte of interest. In some embodiments, each diagnostic well is provided with a different diagnostic component or mixture thereof so as to test for multiple, different analytes within a single fluid sample. References to biological fluid samples herein are provided as non-limiting, representative examples of a fluid sample.

When a target analyte is present in a biological fluid sample that flows onto a diagnostic paper of a diagnostic well, the analyte will selectively associate and react with diagnostic components present on the diagnostic paper. In some embodiments, such reactions cause a color change, wherein the intensity of the color change corresponds to the concentration of the analyte present in the sample. In some embodiments in which the device includes multiple diagnostic wells, a user may rapidly test for multiple diseases and/or patient conditions using just one biological fluid sample and one diagnostic devices because the different diagnostic papers may contain different diagnostic components that selectively associate with different target analytes.

The filter paper layer 203 may be a single layer of filter paper, such as a plasma separation membrane (e.g., D23, TC-1, MFI, F5, combinations thereof, etc.), that is capable of filtering out components that could interfere with the diagnostic reaction. D23 is a whole blood separation media available from I. W. Tremont and is made from borosilicate glass media, 0.5 mm thick. D23-TC-1 is a whole blood separation media, thin caliper available from I. W. Tremont and is made from borosilicate glass media, 0.375 mm thick. MFI is a glass fiber filter typically used for whole blood volumes and is available from Cytiva Life Sciences. F5 is a fast-flow single layer matrix membrane available from Cytiva Life Sciences. For instance, when the fluid sample is whole blood, the filter layer will remove red blood cells from the sample, allowing other target analyte-containing blood component s), such as serum, to vertically pass through the filter layer into the diagnostic layer for reaction with the diagnostic component (s). The type of filter paper in one diagnostic well may be the same as or different from the type of filter paper in one or more other diagnostic wells.

It should be noted that while the current disclosure describes a vertical flow within the diagnostic wells 205, the disclosure is not so limiting. For example as shown in FIG. 2C-2E, in certain embodiments, the top panel 201 and the bottom panel 204 may define slots or other receptacles 305(a) and 305(b) (collectively, 305) that are configured to receive a test strip 310 or other suitable reaction substrate. The strip is comprised of a matrix material through which the fluid test medium and analyte suspended or dissolved therein can flow by capillary action laterally from the application zone to a reaction zone where a detectable signal, or the absence of such, reveals the presence of the analyte. An example test strip may be a lateral flow reagent dip stick configured to be dipped in a test sample (e.g., urine). Although referred to as a “strip,” it can be of any shape or geometry, including rectangular, three dimensional, circular, and so forth.

In certain embodiments, lateral flow test strips may include a membrane system that forms a single fluid flow pathway along the test strip. The membrane system includes components that act as a solid support for diagnostic reactions. For example, porous or bibulous or absorbent materials may be placed on a strip such that they partially overlap, or a single material can be used, in order to conduct liquid along the strip. The membrane materials may be supported on a backing, such as a plastic backing. In a preferred embodiment, the test strip includes a glass fiber pad, a nitrocellulose strip and an absorbent cellulose paper strip supported on a plastic backing.

Automatic methods and apparatus for interpreting test results of dipsticks may include capturing a digital image of both a test strip and a colored reference chart side by side in a single image. However, a user must properly align the test strip and the color reference chart before capturing the digital image that not only exposes a user to test samples but also potentially introduces error in the analysis. In order to overcome these issues, as shown in FIG. 2C, the slots/receptacles may be configured such that one or more reaction zones 311(a)-(c) of the test strip 310 including diagnostic tests are positioned within certain detection regions 315 of the device when the test strip 310 is inserted within a slot. For example, the locations of the detection regions 315 may be determined for ease of image capture of one or more of image registration markers 212(a)-(d), image calibration markers 213(a)-(n), and/or a platform identifier 214 in association with the capture zones 311(a)-(c). The captured image is analyzed using the methods discussed below. While FIG. 2C illustrate slots 305(a) and 305(b) that are provided to expose substantially the entire length of a test strip, FIG. 2E illustrate slots 305(a)(1), 305(a)(2), 305(a)(3) (collectively, 305(a)) and 305(b)(1), 305(b)(2), 305(b)(3) (collectively, 305(b)) that only expose the reaction zones of the test strip within the slot (i.e., at least certain regions between the reaction zones of the test strip are not visible and hidden beneath the top panel). FIG. 2D illustrates a diagnostic device that includes a single detection region 315 that exposes a substantial portion of a lateral flow reaction substrate inserted within, while the markers on the top panel are disposed along a perimeter of the single detection region 315.

It should be noted that a single diagnostic device can include slots for receiving lateral flow reaction substrates and the vertical flow diagnostic wells.

Referring back to FIGS. 2A and 2B, the top panel 201 and the bottom panel 204 may be formed from a solid material such as, without limitation, plastics such as acrylic polymers, acetal resins, polyvinylidene fluoride, polyethylene terephthalate, polytetrafluoroethylene (e.g., TEFLON®), polystyrene, polypropylene, other polymers, thermoplastics, glass, ceramics, metals, and the like, and combinations thereof. In general, the selected solid materials are inert to any solutions/reagents that will contact them during use or storage of the device. Any known fabrication method appropriate to the selected solid material(s) may be employed including, but not limited to, machining, die-cutting, laser-cutting, stereolithography, chemical/laser etching, integral molding, lamination, and combinations thereof.

The top panel 201 is configured to include one or more markers such as, without limitation, image registration markers 212(a)-(d), image calibration markers 213(a)-(n), and at least one platform identifier 214. The one or more markers may be included on the top panel 201 using, for example, direct printing, etching, attachment (e.g., of a decal including the markings) using adhesives, or the like. Other markings such as usage instructions or the like may also be included on the top panel. It should be noted that while FIGS. 2A and 2B show the top panel including the markers, the bottom panel may also include one or more markers (either identical to the top panel or different markers). For example, the bottom panel may be imaged and the image may be analyzed as discussed below to quantify analytes captured on the filter paper.

The image registration markers 212(a)-(d) function to help facilitate spatial locating and/or identification of the spatial orientation of the top panel 201 and/or the diagnostic wells 205(a)-(f) within an image. In some implementations, the image registration markers 212(a)-(d) may be located on the top panel 201 in any suitable arrangement and/or location such as near the corners of the top panel as shown in FIGS. 2A-2E. Other locations and/or number of image registration markers are within the scope of this disclosure depending on, for example, the type of marker, the locations/numbers/shapes of the diagnostic wells, the shape of the top panel, or the like. In some embodiments, the bottom panel may also include various image registration markers (not shown here) that are configured to distinguish the top panel from the bottom panel and/or for spatial image registration (as discussed with respect to 212(a)-(d)). By identifying the image registration markers, an acquired image may be processed and cropped to isolate the test region (e.g., the diagnostic wells) for further analysis without interference from the background of the image (as discussed below). Generally, the image registration markers may include any suitable marker or fiducial, such as ArUco markers, ARTag, QR code markers, other computer-readable markers, or custom markers with sufficiently contrasting visual characteristics.

For example, FIGS. 2A and 2B illustrate ArUco markers as the image registration marker. ArUco markers may include patterns (e.g., a black and white checkerboard patterns) that are unique to each ArUco marker, and can be used to identify a given marker and its position in space (using, for example, a database such as an OpenCV library of ArUco markers). These patterns in the ArUco marker are used to detect the ArUco marker and for ArUco marker based relative positioning, i.e., determining the position and orientation (pose) of the ArUco marker (which may be a camera on a mobile device) with respect to the ArUco marker. Furthermore, if the location of an ArUco marker on the top panel is known, the uniquely identified ArUco marker in a captured image can also be used to determine the location of other features in the image in a local (i.e., relative to the top panel) or a global reference frame. Since the ArUco markers are composed of individual markers, this means that the image capture device does not need to see the entirety of the target (i.e., the top panel 201) in its complete form in order to obtain calibration points. Instead, the image capture device can only partially capture the image of the target and still be able to perform calibration from that target.

In some embodiments, each of the ArUco markers on the top panel (or the bottom panel) provide four corner coordinates for a total of sixteen registration points (since there are four ArUco markers) which can be used to calculate a homography matrix and transform the image to remove perspective as well as align an image of the top panel with a reference or template.

The image calibration markers 213(a)-(n) may include standard color and/or grayscale markings that may function as a reference for color correction (including white balance) by an image sensor, so as to reduce the influence of illuminant or lighting conditions during image capture that may interfere with accurate test result interpretation. As shown in FIGS. 2A and 2B, the color and/or grayscale markings may be applied, without limitation, near a perimeter and/or between the diagnostic wells (or detection regions). However, other locations of image calibration markers are within the scope of this disclosure; and they may be of any colors, sizes, and shapes. One or more embodiments may have any number of color markings and any number of distinct colors for these markers. For example, in one or more embodiments there may be 3 or more color markers with 3 or more distinct colors. In one or more embodiments there may be 9 or more color fiducial markers with 9 or more distinct colors. In one or more embodiments there may be 12 or more color fiducial markers with 12 or more distinct colors. In some embodiments, each color may be represented as a calibration marker at least twice on the top panel (e.g., on opposing side such as upper and lower sides, left and right sides, etc.). This allows for accounting for different illuminations (e.g., shading, angled light source, etc.) at different locations of the panel.

In various embodiments, the precise location of the image registration markers on the top panel is known and stored in a data store. Furthermore, the location of the diagnostic wells and the image calibration markers on the top panel (or relative to the image registration markers) is also known and/or stored. As such, identification of the image registration of the markers can be used to determine location of the diagnostic wells and the image calibration markers.

Additionally and/or alternatively white areas on the top panel may be used by white balancing algorithm(s) for image calibration. Other calibration markers may include patterns such as grids, lines set at different distance apart, lines of different thickness, etc., to test camera characteristics such as resolution, distortion, and blur.

In various embodiments, the platform identifier 214 may include an optical pattern. An optical pattern refers to an optical representation of data presented in a sequence or other pattern which can be read by an optical sensor. Examples of optical patterns include, without limitation, a bar code, Quick Response (QR) code, data codes, and/or the like. When an optical sensor (e.g., a camera of an electronic device) scans a platform identifier, it may detect the corresponding representation of data (e.g., a unique ID associated with the diagnostic device). The unique ID may be associated with a configuration file including information such as, without limitation, the diagnostic device identification, the fluid sample, and the source of the fluid sample (e.g., patient data regarding the patient from which a biological fluid sample was obtained), subject name, subject birth date, target analyte(s), type of assay(s), date of assay(s), type of fluid sample, a template image corresponding to the diagnostic device, location of various features on the diagnostic device (e.g., diagnostic wells, calibration markers, registration markers, or the like), diagnostic tests in various diagnostic wells, machine learning models for diagnostic tests and/or wells of a device, etc.

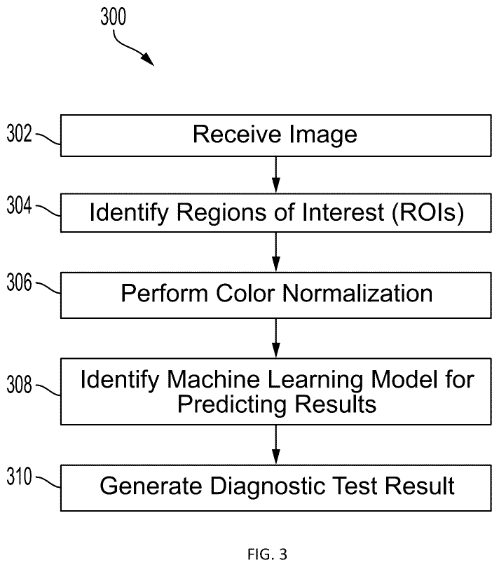

Referring now to FIG. 3, a flowchart of an example method for processing diagnostic assay data and automatically generating diagnostic results. The process 300 describes operations performed in connection with the computing environment of FIG. 1. In one specific example, the process 300 may represent an algorithm that can be used to implement one or more software applications that direct operations of a various components of the computing environment 100.

The methods may start at 302 when an image corresponding to a diagnostic device is received. The image may be received from an image capture device (e.g., a camera of a mobile device). In various embodiments, a fluid sample may first be deposited onto one or more diagnostic wells of a diagnostic device such that the fluid sample flows vertically to the diagnostic paper, via the filter paper. Once the fluid sample contacts the diagnostic paper, a reaction may occur, and the test may complete to provide a visual indication of the test results (e.g., a color change, appearance of a line, or the like).

Optionally, the received image may be processed to, for example, crop the image, remove shadows, remove artifacts, perform noise filtering, scale the image, perform color correction, align the image to generate a straight-on perspective, or the like.

Additionally and/or alternatively, the received image may include control markings that include suitable markings that are representative of one or more predetermined test results for the diagnostic test, as described in further detail above. The system may assess whether all (or a sufficient portion) of the control markings may be detected in the image. If not all of the control markings are detected in the image, then the user may be notified of the error. For example, a suggestion may be provided to the user to try a different camera, change one or more camera settings, adjust one or more environmental factors, or any combination thereof, etc. If the control markings are detected in the image, then the image may be further analyzed to predict the diagnostic test result, and the test result may be output or otherwise communicated such as that as described below.

In some embodiments, the methods may include providing real-time feedback to a user (e.g., via a display device of an image capture device) for capturing a high quality image prior to capturing a final image of the diagnostic device. The real-time feedback may be provided to address issues such as a shadow cast by the image capture device on the diagnostic device during image capture, a glare caused by a flash of the image capture device, or the like. The feedback may, therefore, reduce image processing required post capture, improve accuracy of results, reduce duplication of image capture, etc.

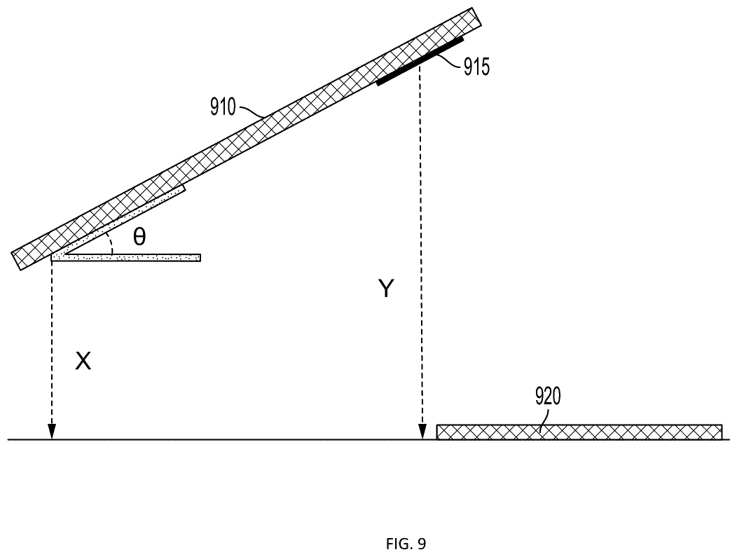

For example, capturing the image at a first relative orientation and/or alignment between the image capture device (e.g., camera of a mobile device) and the diagnostic platform may reduce the glare caused by a flash of the image capture device. For example, the orientation of the image capture device with respect to the diagnostic device for reduction of glare may be about 20 to about 40 degrees, about 22 to about 38 degrees, about 22 to about 27 degrees, about 20 to about 29 degrees, about 24 to about 36 degrees, about 26 to about 34 degrees, or the like. Additionally and/or alternatively, the distance of the camera of the image capture device from the diagnostic device may be about 30 to about 40 cm, about 32 to about 38 cm, about 25 to about 45 cm, about 32 cm, about 34 cm, about 36 cm, or the like. As shown in FIG. 9, the image capture device 910 may be held in a position with respect to the diagnostic device to achieve a desired orientation and/or distance of the camera 915 with respect to diagnostic device 920.

In certain embodiments, the methods may provide for detecting parameters on a mobile device related to properties of an image capture device (e.g., location within the mobile device, resolution, flash illumination, number of cameras, etc.) in real-time and automatically configuring the feedback for allowing a user to capture a high quality image. In some examples, a user is provided a the distance and/or the angle at which the image capture device should be held during the image capture of the diagnostic device. Optionally, the user receives feedback in real-time on the quality of the image. This feedback can include, without limitation, one or more of the following:
1. Real-time framing around the ‘edge’ of the diagnostic device. In one embodiment, a colored line is drawn around the edge of the diagnostic device to form a frame. For example, the frame color is a first color e.g., (red) if the diagnostic device is too far away or too close and or a second color (e.g., green) when the image is properly positioned within the frame. Optionally, an arrow, text or other indication may be provided to the user to indicate the direction in which the image capture device needs to be moved.
2. Image orientation: The shape of the frame may be configured to guide the user to adjust an orientation of the diagnostic device with respect to the camera. For example, a parallelogram or quadrilateral indicates the device must be tilted to avoid glare, and the frame color may change to indicate appropriate level of tilting (e.g., red and green). Optionally, an arrow, text or other indication may be provided to the user to indicate whether the direction in which the image capture device needs to be tilted.
3. Image crispness feedback on the crispness of the image. This feedback may be presented through messages appearing on the screen of the image capture device (e.g., in a semi-transparent font, in a suitable color, etc.) indicating whether the user is moving the mobile device too much. Crispness is determined via edge detection by looking at how ‘crisp’ the edges of the diagnostic device are. The user may be given real-time feedback as they hold the camera steadier, by changing the message or changing the color of the real-time frame.
4. Color Indicators. As the user moves the mobile device over the diagnostic device, a color indicator changes from a first color to a second color when the diagnostic device is properly placed within the frame and edge detection determines that the diagnostic device is determined to be in the right position/orientation (e.g., in focus).
5. Contrast Indicators. If the contrast of the image is too low, a message is displayed on the mobile device screen which will alert the user to this fact.
6. Reflection Indicators. A message will be displayed to the user that they need to change the lighting conditions or perspective of the mobile device with respect to the diagnostic device to remove the reflective area or glare.

Referring back to FIG. 3, at 304, the image may be processed to identify the region of interests (ROIs) such as one or more of the diagnostic wells or detection regions (in the case of a lateral flow assay) within the image.

In one or more implementations, the ROIs may be identified by first extracting the image registration markers (e.g., the ArUco markers) in the image using any now or hereafter known methods (e.g., an object detection classifier). The image registration markers may be used for registering the image to a reference image (e.g., an image of a reference top panel) of the identified diagnostic device. As discussed above, each of the ArUco markers includes a unique checkerboard pattern, and four unique ArUCo markers are formed at or near the four corners of the top panel of the diagnostic device. A typical ArUco marker is a big black square with multiple smaller white and black squares inside it. These small squares define the unique code of the marker and allows the use of a large number of easily distinguishable codes, while reducing susceptibility to interference (e.g., changes in lighting). The detected and identified markers can, therefore, be used to determine the pose of the image capture device in a desired global frame of reference to allow for calibration of the image capture device. Such calibration may take into account the distance of the image capture device from the top panel and/or orientation the image capture device relative to the top panel. For example, once a marker has been detected, it is possible to estimate its pose with respect to the camera by iteratively minimizing the reprojection error of the corners.

Furthermore, given the determined camera pose and the platform identifier, the detected and identified markers are compared with a database of previously stored ArUco markers and their corresponding locations on the diagnostic device to accurately determine the corners of the top panel in the received image, using any now or hereafter known methods. The identified corners may then be aligned (or registered) with the reference image.

Optionally, the platform identifier may be extracted automatically (from, for example, a QR code) and/or manually, and maybe to determine one or more characteristics of the diagnostic device in the image (using the configuration file discussed above). The characteristics may include, without limitation, the identification of the diagnostic device, which may in turn may be used to determine the location of various features on the diagnostic device (e.g., the image registration markers, the image calibration markers, the diagnostic wells, or the like) and/or a template image corresponding to the diagnostic device (e.g., a template image of the top panel). The QR code may be extracted and matched using any now or hereafter know image analysis methods (e.g., an object detection classifier, built-in functions of OpenCV and/or similar computer vision software packages).

Based on the location of the ArUco markers and/or the corners of the top panel with respect to the reference image, the diagnostic wells (and/or detection regions) may be located within the received image, the diagnostic wells (and/or detection regions) being the ROIs. As discussed above, an estimated location of the diagnostic wells (and/or detection regions) for a given diagnostic device may be known and may be extracted from an image that has been registered to the template image. The template image may be known and referenced based on the unique identification information included in the QR code. For example, an input image of the diagnostic platform is obtained from a mobile device. The detected ArUco markers are used to calculate a 3×3 homography matrix that is then used to warp the input image perspective until it is aligned and registered with the known template image.

Optionally, portions of the image corresponding to the diagnostic wells (and/or detection regions) may be extracted, cropped, and/or otherwise isolated from the image for further analysis.

Next, at 306, color normalization is performed on the identified ROI(s) to normalize the color of the ROI(s) for a reference illumination. Optionally, the color normalization may be performed on the entire image and the ROIs may be extracted after the color normalization step using the process discussed above. The color normalization step allows for accurate image analysis by taking into account different illumination conditions (e.g., outside a laboratory) during image acquisition. Specifically, the color normalization may be used to transform the appearance of the ROIs into their projected appearance under reference lighting conditions. The color normalization may be performed in any now or hereafter known color spaces such as, without limitation, CIELAB standard color space, Adobe sRGB standard color space, YUV standard color space, CIELAB standard color space, CIE XYZ standard color space, HSV color space, HSL color space, or the like. For assay reactions which may progress across shades of the same color, HSV may be preferable as the value (V) provides a univariate way of measuring shade changes to a single color. In other cases where small visual differences matter, CIELAB is the most useful as it was designed around the concept of perceptual uniformity.

Optionally, the color normalization process includes one or more of the following 3 steps: (i) white balancing; (ii) multi-variate gaussian distribution; and (iii) histogram regression.

The human eyes and brain can adjust to different color temperatures. For instance, humans see a white object as white regardless of whether it is viewed under strong sunlight or in a room illuminated with incandescent lights. Digital camera devices usually have built-in sensors to measure the color temperature of a scene, and may use an algorithm to process captured images of the scene so that the final result is close to how a human would perceive the scene. This adjustment to make the white colors in the image resemble the white colors in the scene is referred to as white balancing. Any now or hereafter known white balancing methods may be used. For example, in an embodiment, white balancing may include utilizing a known value of white corresponding to a point or an area on the diagnostic device (e.g., a white colored calibration marker), and comparing it to the captured image of that same point/are (i.e., the same white colored calibration marker). The comparison may then be used to create a transformation matrix or coefficient for transforming the captured image of the diagnostic device to a first transformed image that includes the white colored calibration marker having the known white value. Optionally, white balancing may not be performed, for example, when the image is captured in a controlled illumination environment.

Next, for performing color normalization the calibration markers in the acquired image may be located by, for example, using the configuration file corresponding to the diagnostic device that may include the location of the calibration markers on a template image, and after the acquired image is registered with respect to the template image (e.g., using the registration process discussed above). Once the calibration markers have been located, images of those calibration markers may be converted to a color space that is best suited for the analysis of their color. Next, a color transformation may be performed to transform the source image's color distribution close to the color distribution of the image calibration markers. A global transformation function may be utilized for transforming the received image to a color normalized image. The global transformation function may be generated by first acquiring a plurality of images of the image calibration markers (e.g., RGB colors) of the diagnostic device under a reference illumination (e.g., a D50 illumination in the CIELAB color space). The images of the image calibration markers are then compared to the images of the calibration markers in the acquired image (while ignoring the ROIs in the acquired image) to generate the global transformation function. In an example embodiment, the global transformation by fitting the distributions of the source and target images using, for example, the multivariate Gaussian distribution (MVGD). Other parametric and non-parametric methods for generation of the global transformation function using the source and target distributions are within the scope of this disclosure.

The method includes extracting all pixels from the calibration markers in the captured image (source) and comparing the extracted pixel color values to the corresponding expected pixel color values of the calibration markers under the D50 illuminant assumption (target). In an example embodiment, the colors are represented in the CIELAB space. By simultaneously considering all three color channels (red, blue, and green), the method may create a mapping plane between the source and the target that allows any source pixel's color to be transformed in a linear or nonlinear fashion in order to closely resemble the colors of the target.

An example diagnostic device may include 24 unique colors of calibration markers duplicated to 48 total chips that cover a broad spectrum of visible color space (the number of unique colors is provided only as an example and is not limiting). Optionally, at least one (1, 2, 3, etc.) white and at least one (1, 2, 3, etc.) black calibration marker may be included. These unique colors are printed on the diagnostic device in order to consistently measure with a deltaE 2000 less than 5 under the standard D50 illuminant (i.e., printed with a high degree of fidelity to the originally designed colors). The Illuminant D standard defines the expected temperature of visible light illuminating a scene. D50 is broadly used in the printing industry as the standard illuminant when calculating the ink mixtures to present a final color on the printing substrate. *deltaE 2000 is a CIE standard equation that determines the perceptual similarity between two colors. A value <5 can be interpreted as a color difference visible only through close observation.

Any variation in illumination conditions, therefore, will be due to the light source illuminating the diagnostic device during image capture (i.e., a light source that is NOT 5000K like the D50 states). This property may be used to quantify the new color of each calibration marker and measure that difference between the theoretical values under the D50 illuminant. With these quantitative differences, the system may determine a multivariate gaussian distribution color transfer matrix that can be used to apply a global image correction to bring the measured colors back in line with the theoretical D50 colors. This requires no pre-calculated profiles or lookup tables and only assumes that each calibration marker is exposed to the same source of illumination and should look like the originally printed colors.

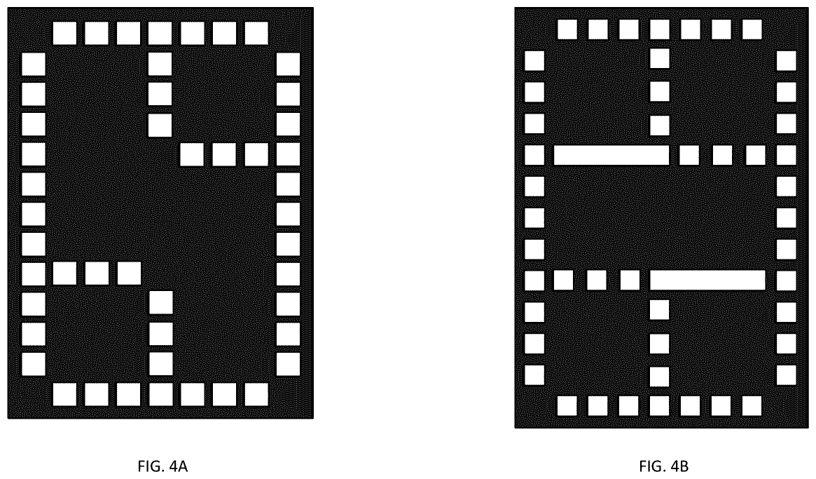

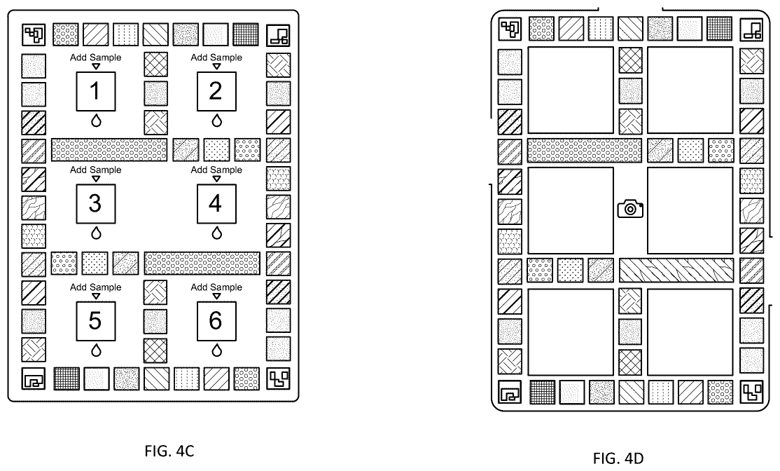

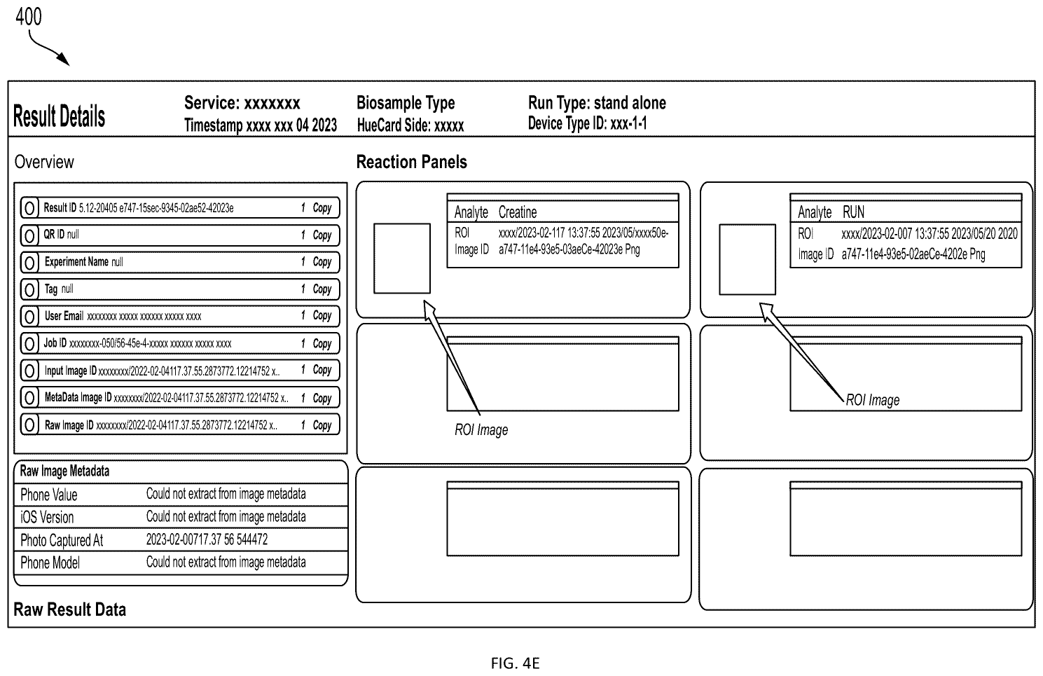

To accommodate the reaction spaces (i.e., the diagnostic wells) present in the diagnostic platform, a masking capability is implemented to operate only on the calibration marker images for generating the global transformation function. This permits dynamic selection of particular regions within the source and target when creating the distribution mapping plane, rather than applying the process to the entire source and target images. The masking is then extended into a universally applicable masking process compatible with any color correction algorithm. For example, a pre-defined color chip location mask (example, as shown in FIGS. 4A and 4B) may be used to extract only the color correction chip values from both the template and input images. For example, a masking operation is performed to obtain the image shown in FIG. 4C and/or the image shown in FIG. 4D. These color values are represented by two K×3 arrays, one for each image (i.e., the template image and the input image). These two arrays are then used in the fourth step to calculate the color correction matrices according to the approaches listed above. If a color transfer matrix was calculated, the dot product is taken to transform the input color space to match the template's color space. If a mapping function was calculated, each color in the input image is recalculated and mapped to a new color that reflects the template's color space. A color transformation is performed on the masked image as shown in FIG. 4E. The system furthermore implements a processing pipeline that allows correction chaining for performing “n” number (e.g., 3, 4, 5, 6, 7, 8, 9, 10, etc.) of masking operations and color correction algorithms that are sequentially applied to an image before the results are finalized. A global transformation is then applied across the entire image for color correction of the ROIs.

The global transformation function is then applied to the whole acquired image (and/or the extracted ROIs) to generate the color normalized image(s). Optionally, the ROIs may be extracted after performing color correction. Optionally, a histogram mapping step may be used to further process the ROI images. Specifically, the ROI images are processed to reduce the feature space by using dimensionality reduction. This may involve calculating a histogram of color values for each color channel of the image. For example, an RGB image would have 3 histograms calculated for the red, green and blue color channels of the image. These three histograms are concatenated into a single array of values. Specifically, histogram mapping further examines each individual color channel rather than all three simultaneously as in the MVGD step. Each color channel is then shifted in such a way that the source distribution of colors more closely resembles the target distribution of colors. The colors channels are then recombined into a single image. Optionally, the histogram mapping algorithm may only be applied to particular areas of the image (e.g., the ROIs) and use just the calibration markers instead of the entire image (using the masking process discussed above). In various embodiments, the histogram mapping may utilize linear interpolants (e.g., linear piecewise interpolant to extrapolate values in an 8-bit numerical space) and/or nonlinear interpolants. (e.g., polynomial interpolation and least squares regression in the more precise 32-bit space). In some embodiments, other dimensionality reduction algorithms may be used in addition to or in lieu of histogram mapping such as, without limitation, Principal Component Analysis (PCA) to reduce the feature space.

The MVGD color normalization may, optionally, be repeated after histogram mapping to further process the ROIs. As such, in some embodiments, color normalization includes first global transformation (e.g., using MVGD) followed by dimensionality reduction (e.g., using histogram mapping) followed by second global transformation (e.g., using MVGD) to output final color normalized image and/or ROIs.

The ROI image(s) may then be analyzed to predict a test result using one or more suitable trained machine learning models. For example, a machine learning model may be trained using training data including images with labeled and/or unlabeled test results (e.g., faint positive, moderately strong positive, strong positive, qualitative values, etc.) for various kinds of diagnostic tests. This machine learning models may be trained in unsupervised or semi-supervised manners may additionally or alternatively be used to predict a test result from the image. The resulting normalized ROI color values are imputed into the model for prediction.

Any now or hereafter known machine learning model may be used such as, without limitation, neural networks, regression models, clustering models, density estimation models, deep learning models, Nearest Neighbor, Naive Bayes, Decision Trees, or the like.

As used herein, a “machine learning model” or “model” each refers to a set of algorithmic routines and parameters that can predict an output(s) of a real-world process (e.g., to provide diagnostic results of a processed fluid sample, etc.) based on a set of input features, without being explicitly programmed. A structure of the software routines (e.g., number of subroutines and relation between them) and/or the values of the parameters can be determined in a training process, which can use actual results of the real-world process that is being modeled. Such systems or models are understood to be necessarily rooted in computer technology, and in fact, cannot be implemented or even exist in the absence of computing technology. While machine learning systems utilize various types of statistical analyses, machine learning systems are distinguished from statistical analyses by virtue of the ability to learn without explicit programming and being rooted in computer technology.

In various embodiments, a machine-learning model may be associated with one or more classifiers, which may be used to classify one or more objects (e.g., ROI image colors). A classifier refers to an automated process by which an artificial intelligence system may assign a label or category to one or more data points. A classifier may include an algorithm that is trained via an automated process such as machine learning. A classifier typically starts with a set of labeled or unlabeled training data and applies one or more algorithms to detect one or more features and/or patterns within data that correspond to various labels or classes. The algorithms may include, without limitation, those as simple as decision trees, as complex as Naive Bayes classification, and/or intermediate algorithms such as k-nearest neighbor. Classifiers may include artificial neural networks (ANNs), support vector machine classifiers, and/or any of a host of different types of classifiers. Once trained, the classifier may then classify new data points using the knowledge base that it learned during training. The process of training a classifier can evolve over time, as classifiers may be periodically trained on updated data, and they may learn from being provided information about data that they may have mis-classified. A classifier will be implemented by a processor executing programming instructions, and it may operate on large data sets such as image data and/or other data.

At 308, the platform identifier may be used to identify a trained machine learning model to be used for analyzing the color normalized ROIs and generating a diagnostic result. In various implementations, the platform identifier may be used to determine the diagnostic tests included in one or more of the diagnostic wells and/or the machine learning model to be used for predicting the test result (e.g., from the configuration file). Optionally, the system may then look up the machine learning model that has been previously trained to analyze the image corresponding to that diagnostic test for providing a diagnostic result. For example, based on the platform identifier, the system may determine that diagnostic well “X” of the identified platform includes a diagnostic test for levels of alanine transaminase (ALT) in a blood sample, and that has a corresponding machine learning model trained for performing colorimetry based image analysis. Optionally, the image may incorporate known characteristics of the diagnostic test being imaged. For example, the type (e.g., brand, etc.) of the diagnostic test may be determined, and one or more characteristics such as overall shape or aspect ratio of the diagnostic test may be known for that type of diagnostic test (e.g., in a stored configuration file). Information from the configuration file for that diagnostic test may be utilized in verifying appropriate size and/or shape of the ROI in the image, for example. The type of the diagnostic test may be determined automatically (e.g., optical character recognition of branding on the imaged diagnostic test, other distinctive features, machine learning, template matching, etc.) and/or through manual input on a computing device (e.g., selected by a user from a displayed, prepopulated list of diagnostic tests with known characteristics). In some variations, a proposed diagnostic test type determined through automated methods may then be manually confirmed or corrected by the user.

The identified machine learning model may analyze the color normalized ROI and provide a diagnostic result (310).

In one or more embodiments, a given ROI color may correspond to one or two types of results, depending on the type of diagnostic test with which the color is associated. For example, for metabolic tests, the colors are quantitative—a certain collection of RGB values (or color values in another color space) represents a single quantitative number (e.g., a target analyte concentration). Alternatively, for a binary diagnostic test (e.g., a positive or negative result) the presence or absence of a color (or colors) can indicate a positive or negative result.

Furthermore, in some variations, the method may further include communicating the predicted diagnostic test result to a user or other entity, and/or storing the diagnostic test result (e.g., in a user's electronic health record, in a user account associated with the diagnostic device, etc.). For example, in some variations the test result may be communicated to the user through a mobile application associated with the diagnostic device, through a notification message, through email, or in any suitable manner. Additionally or alternatively, the diagnostic test results may be communicated to a medical care team for the user, such as through an associated dashboard or other suitable system in communication with the diagnostic device. Furthermore, in some variations the diagnostic test results may be communicated to a suitable electronic health record for the user or other memory storage device.

It should be noted that while the above method performs the step color normalization to account for changes in illumination during image capture, the method may be used without the color normalization step (e.g., when the image is captured in an environment that has a constant illumination) for predicting the diagnostic test results.

Optionally, the diagnostic test results may be displayed in a graphical user-interface generated at a mobile device. Such graphical-user interfaces (GUIs) may include various buttons, fields, forms, components, data streams, and/or the like, any of which may be used to visualize the results. An example, GUI 400 is shown in FIG. 4E.

The diagnostic device may, in some variations, assist in one or more various follow-up actions in view of the predicted test result. For example, the diagnostic device may help the user become connected with a suitable medical care practitioner to discuss questions or options for proceeding with medical care. The diagnostic device may suggest and/or facilitate an in-person visit with a medical care practitioner in appropriate. Additionally or alternatively, the diagnostic device may assist in providing prescriptions for appropriate medications, provide general medical guidance and/or links to resources or supplements, and/or other suitable actions to further the medical care of the user in view of the diagnostic test results.

In some variations, the method may be used in conjunction with diagnostic test kits such as those known in the art (or components thereof). The method may be performed locally such as on a mobile computing device (e.g., mobile application executed on the mobile device and is associated with the diagnostic device), and/or remotely such as on a server (e.g., cloud server).

### Machine Learning Model Selection and Training

With a range of candidate models may being trained using training data (e.g., diagnostic test images with corresponding test results) for a particular diagnostic test, there exists a need for comparing machine learning models and selecting an optimal model. This problem is exacerbated when a model needs to selected for each individual diagnostic test that can be included on a diagnostic device. Furthermore, for a given selection of a machine learning model, the selection/optimization of features and hyperparameters (i.e., experimental design) may require exponential iteration over the entire variable space in order to optimize those values for the most performant assay. The comparison and selection process for both the model and the variables (i.e., features/hyperparameters) needs to be repeatable and must provide a meaningful performance metric for different diagnostic tests.

This disclosure describes systems and methods for machine learning model selection, i.e., to facilitate the choice of appropriate machine learning model(s) for performing image analysis and predicting tests results of a particular diagnostic test. The disclosure describes comparison of candidate machine learning models to calculate and/or to estimate the performance of one or more machine learning algorithms configured with one or more specific parameters (also referred to as hyper-parameters) with respect to a given set of data. The disclosure further describes a Bayesian optimization based approach for selection of the best hyperparameters that results in the highest level of model performance.

Referring now to FIG. 5, a flowchart of an example method for selecting a machine learning model, and selection and/or optimization of the selection model hyperparameters is illustrated. The process 500 describes operations performed in connection with the computing environment of FIG. 1. In one specific example, the process 500 may represent an algorithm that can be used to implement one or more software applications that direct operations of a various components of the computing environment 100.

At 502, the system may receive input datasets and performance criteria. Optionally, the system may also receive a selection of machine learning models to be evaluated. For example, a system may receive example input datasets and performance criteria from a user's computing device.

The input dataset may be a labeled dataset (also called an annotated dataset, a learning dataset, or a classified dataset), meaning that the dataset includes input data (e.g., values of observables, also called the raw data) and known output data for a sufficient number (optionally all) of the input data. The example input datasets can include, but are not limited to, raw images and inference data corresponding to a plurality of images for a colorimetry based analyte assay (including any corresponding metadata).

Performance criteria can include, for example, accuracy, precision, coefficient of variation, limit of detection, limit of quantification, or any other metric that may appropriately reflect real-world performance expectations for the analyte assay and for predicting test results via image analysis. Optionally, the training datasets may be preprocessed.

The selection of machine learning model may be received from, for example a machine learning library (of the system in FIG. 1). Each machine learning model may be associated with different parameters. For example, an artificial neural network may include parameters specifying the number of nodes, the cost function, the learning rate, the learning rate decay, and the maximum iterations. Learned decision trees may include parameters specifying the number of trees (for ensembles or random forests) and the number of tries (i.e., the number of features/predictions to try at each branch). Support vector machines may include parameters specifying the kernel type and kernel parameters. Not all machine learning algorithms have associated parameters. As used herein, a machine learning model is the combination of at least a machine learning algorithm and its associated parameter(s), if any.

The received images (i.e., the input data set) may be processed for feature extraction and/or a feature selection process from the training datasets (504) to generate a feature dataset. Feature selection generally selects a subset of the input data values. Feature extraction, which also may be referred to as dimensionality reduction, generally transforms one or more input data values into a new data value. Feature selection and feature extraction may be combined into a single algorithm. Feature selection and/or feature extraction may preprocess the input data to simplify training, to remove redundant or irrelevant data, to identify important features (and/or input data), and/or to identify feature (and/or input data) relationships. Feature extraction may include determining a statistic of the input feature data. The feature discovery and selection process can use any now or hereafter known supervised and unsupervised feature extraction techniques. For example, the input images (including training, test and inference) may be processed to reduce the dimensionality of the images for selecting and/or combining the image variables into features. For example, the system may be configured to discretize, to apply independent component analysis to, to apply principal component analysis to, to eliminate missing data from (e.g., to remove records and/or to estimate data), to select features from, and/or to extract features from the input dataset and generate a feature dataset.

In various implementations, the feature discovery and/or selection may include creation of raw histogram information (initial features) from the images' color channels, which are processed using principle component analysis (PCA) to generate a smaller (k<32) number of final image features that account for almost all the variation in an image's colors. The final image features from the training datasets form the feature dataset.

Optionally, a measure of correlation between the selected features and the performance criteria may also be determined, and used to further select a subset of features that have a positive impact on the performance criteria.

Next, the feature dataset may be used for training and evaluating a plurality of machine learning model to produce a performance result for each machine learning model (506). Training and evaluating 506 may include using a subset and/or derivative of the feature dataset, and each machine learning model may be trained and evaluated with the same or different subsets and/or derivatives of the feature dataset. Training and evaluating 506 generally includes performing supervised learning with at least a subset and/or a derivative of the input feature dataset for each machine learning algorithm. Training and evaluating 506 with the same information for each machine learning model may facilitate comparison of the selection of machine learning models.

Training and evaluating 506 may include designing and carrying out (performing) experiments (trials) to test each of the machine learning models of the selection of machine learning models. Training and evaluating 506 may include determining the order of machine learning models to test and/or which machine learning models to test. Training and evaluating 506 may include designing experiments to be performed independently and/or in parallel (e.g., at least partially concurrently). Training and evaluating 106 may include performing one or more experiments (training and/or evaluating a machine learning model) in parallel (e.g., at least partially concurrently.

In various implementations, training and evaluating 506 may include dividing the feature dataset into a training dataset and a corresponding evaluation dataset for each machine learning model, training the machine learning model with the training dataset and evaluating the trained model with the evaluation dataset. Dividing may be performed independently for at least one (optionally each) machine learning model. Additionally or alternatively, dividing may be performed to produce the same training dataset and the same corresponding evaluation dataset for one or more (optionally all) machine learning models. In various implementations, the training dataset and the evaluation dataset may be independent, sharing no input data and/or values related to the same input data (e.g., to avoid bias in the training process). The training dataset and the evaluation dataset may be complementary subsets of the input feature dataset and may be identically and independently distributed, i.e., the training dataset and the evaluation dataset have no overlap of data and show substantially the same statistical distribution.

Training includes training each machine learning model with a training dataset to produce a trained model for each machine learning model. Evaluating includes evaluating each trained model with the corresponding evaluation dataset. The trained model is applied to the evaluation dataset to produce a result (a prediction) for each of the input values of the evaluation dataset and the results are compared to the known output values of the evaluation dataset. The comparison may be referred to as an evaluation result and/or a performance result.

Training and evaluating 506 may include validation and/or cross validation (multiple rounds of validation), e.g., cross-validation, leave-one-out cross validation, and/or k-fold cross validation, or the like. Cross validation is a process in which the original dataset is divided multiple times (to form multiple training datasets and corresponding evaluation datasets), the machine learning model is trained and evaluated with each division (each training dataset and corresponding evaluation dataset) to produce an evaluation result for each division, and the evaluation results are combined to produce the performance result. For example, in k-fold cross validation, the original dataset may be divided into k chunks. For each round of validation, one of the chunks is the evaluation dataset and the remaining chunks are the training dataset. For each round of validation, which chunk is the evaluation dataset is changed. In leave-one-out cross validation, each instance to be evaluated by the model is its own chunk. Hence, leave-one-out cross validation is the case of k-fold cross validation where k is the number of data points (each data point is a tuple of features). The combination of the evaluation results to produce the performance result may be by averaging the evaluation results, accumulating the evaluation results, and/or other statistical combinations of the evaluation results. Training and evaluating 506 may include repeatedly dividing the dataset to perform multiple rounds of training and evaluation (i.e., rounds of validation) and combining the (evaluation) results of the multiple rounds of training and evaluation to produce the performance result for each machine learning model. Any number of rounds of validation (e.g., 3, 4, 5, 6, or the like) may be performed. Combining the evaluation results to produce the performance result may be by averaging the evaluation results, accumulating the evaluation results, and/or other statistical combinations of the evaluation results.

The performance result for each machine learning model and/or the individual evaluation results for each round of validation may include an indicator, value, and/or result related to a correlation coefficient, a mean square error, a confidence interval, an accuracy, a number of true positives, a number of true negatives, a number of false positives, a number of false negatives, a sensitivity, a positive predictive value, a specificity, a negative predictive value, a false positive rate, a false discovery rate, a false negative rate, and/or a false omission rate. Additionally or alternatively, the indicator, value, and/or result may be related to computational efficiency, memory required, and/or execution speed. The performance result for each machine learning model may include at least one indicator, value, and/or result of the same type (e.g., all performance results include an accuracy). The performance result for each machine learning model may include different types of indicators, values, and/or results (e.g., one performance result may include a confidence interval and one performance result may include a false positive rate).

The performance result may be compared to a threshold (508) to select one or more of the models being evaluated as candidate models. In various implementations, the threshold may be determined based on the performance criteria. For example, one performance threshold may relate to the minimum required performance level or accuracy to achieve a competitive advantage in the market. Any model not able to achieve this level of performance is removed from consideration as a candidate model.

In various implementations, each of the candidate models are optimized or fine-tuned using Bayesian optimization to select the best corresponding hyperparameters that results in the highest level of model performance (510). Bayesian optimization builds a probability model of the objective function and uses it to select the most promising hyperparameters to evaluate in the true objective function. Bayesian approaches keep track of past evaluation results which they use to form a probabilistic model mapping hyperparameters to a probability of a score on the objective function for choosing hyperparameters in an informed manner.

Upon fine-tuning of each of the candidate models, the highest performing model is selected as the machine learning model for predicting the test results of an assay (512). Optionally, further testing may be performed to ensure integration with the complete system is successful. This process involved unit testing and integration testing which simulates the use of the entire system and its components end-to-end. Any problematic behavior introduced by the model will be caught and can be addressed before final integration into a production setting.

The selected model may be trained for generating a trained deployable machine learning model. In various embodiments, training the model may include trained with the entire input dataset (as optionally preprocessed to generate the feature dataset). It should be noted that the training may be a continuous process where the model may be updated after deployment to improve its performance over time (e.g., using images for which the trained model is used to predict results for).

### EXPERIMENTAL DESIGN

The Bayesian optimization discussed above may also be used for designing optimal assays for an analyte. Typically, design of an assay for an analyte for predicting test results includes experimental design, result evaluation, and fitting. In various embodiments, the volumetric ratio of bio sample applied to a test paper versus the volume of assay compound initially applied to the test paper during manufacturing may be based on the determined experimental design.

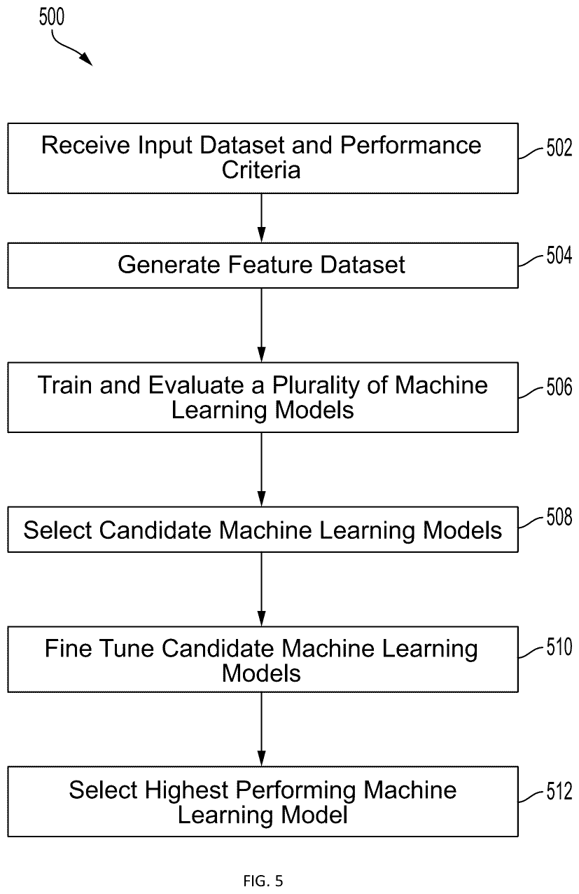

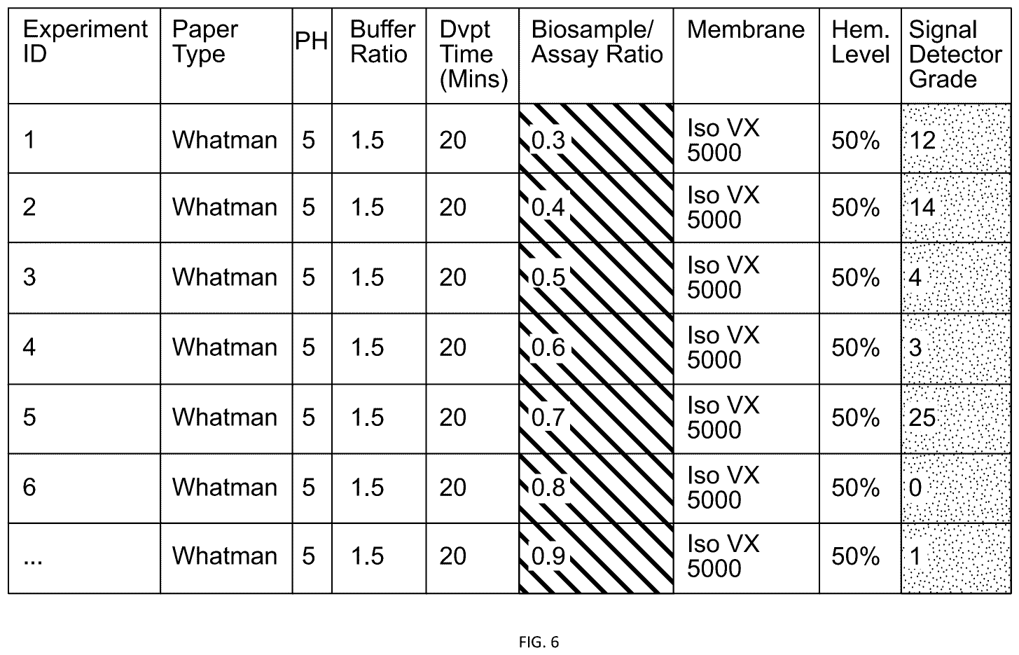

An example of how experiments are planned in the standard way is shown in FIG. 6, where each row represents a multi-hour experiment. In this example, all variables are held constant except for the variable to be optimized. In the example shown in FIG. 6, the Biosample/Assay reagent Ratio is varied across a number of experiments. (6+shown in FIG. 6). For each experiment, an image of the reaction on the diagnostic paper is captured and input into a signal detector that is an algorithm configured to take images of a collection of colorimetric reactions as an input to output as a quantitative “grade” of the assay, an effectiveness and likelihood that the assay can be used for analyte detection and/or quantification. As shown in FIG. 6, a final “grade” for that experiment is produced, indicating whether the results of that experiment are favorable for using that assay. This traditional method of experimental design requires exponential iteration over the entire variable space in order to optimize those values for the most performant assay. This traditional method of experimental design requires exponential iteration over the entire variable space in order to optimize those values for the most performant assay making it time consuming, prone to errors and cumbersome.

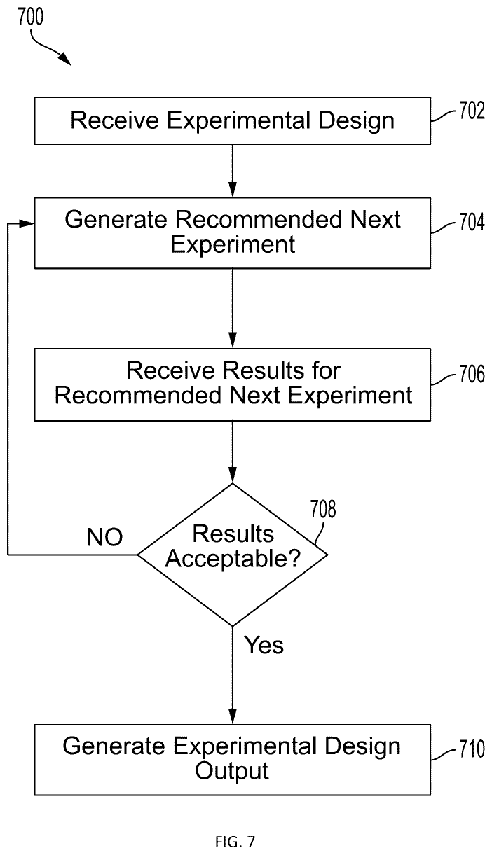

The current disclosure describes using Bayesian optimization for optimization of experimental design leading to the reduction of the number of experiments needed to develop an assay dramatically (e.g., up to 90%). Referring now to FIG. 7, a flowchart of an example method for designing a configuration of experimental variables, and selection and/or optimization of the experimental variables for the next sequential experiment to be performed. The process 700 describes operations performed in connection with the computing environment of FIG. 1. In one specific example, the process 700 may represent an algorithm that can be used to implement one or more software applications that direct operations of a various components of the computing environment 700.

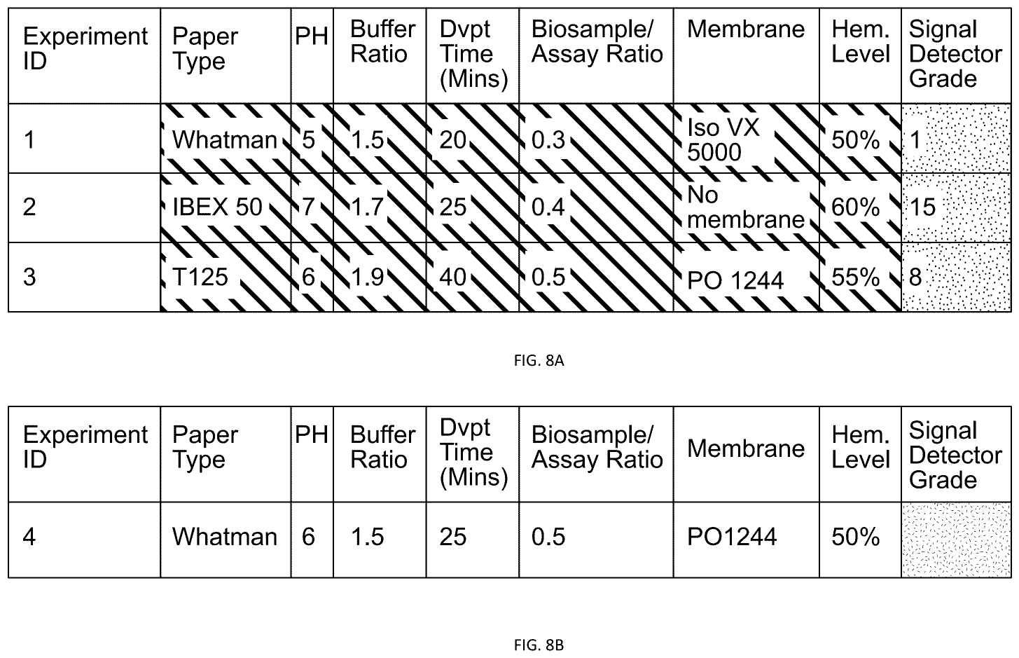

In various implementations, a first set of “n” (e.g., n is <3, 4, 5, etc.) experiments may be performed where all the variables in the experiment design space are varied, and the grade of the assay is recorded. The system may receive the experiment design and the corresponding grades in step 702. For example, FIG. 8A illustrates 3 experiments with different values of the variable and corresponding grades.

Next, the experiment data (including the variables and grades) as well as the realistic boundaries of the variable space are used to generate a recommended next experiment (704). In various implementations, the recommended next experiment may be generated using a Bayesian optimizer based on the received experiment data and variable space. An example recommended next experiment is illustrated in FIG. 8B. For example, a Gaussian process (GP) or another model may generate a function or a model (e.g., a model of predicted mean and uncertainty at any given point in the input space) given the received experiment data as a set of observations in the input space. A most promising design for the next experiment may be generated in order to reduce the time required to arrive at a maximally-favorable signal detector grade of any one experiment, indicating that the particular configuration of experimental variables is sufficient to proceed with developing a marketable product.

The recommended next experiment may be executed (e.g., by a user), and the corresponding results (e.g., grade) may be received from the user (706). At 708, the system may determine whether the results are acceptable. The results may be acceptable when the variable space has been optimized and the grade is maximized. If the results are not acceptable (708: NO), the system may use the received results in association with the previously received data (in step 702) to again generate a new recommended next experiment (704) to maximize the signal detector grade. This process is repeated until the variable space has been optimized and the grade is maximized, and the final recommended experimental design is output (710). The final generated experimental design may be used as an analyte assay for use with the diagnostic device of this disclosure, and for predicting test results as discussed above.

Since the variable space does not need to be manually and serially explored, the number of experiments needed to discover the optimal combination of variables is reduced substantially.

FIG. 10 illustrates an example of a suitable computing and networking environment 1000 that may be used to implement various aspects of the present disclosure. As illustrated, the computing and networking environment 1000 includes a computing device, although it is contemplated that the networking environment of the computing and networking environment 1000 may include one or more other computing systems, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments that include any of the above computing systems or devices, and the like.

Components of the computing and networking environment 1000 (e.g., a computer) may include various hardware components, such as a processing unit 1002, a data storage 1004 (e.g., a system memory), and a system bus 1006 that couples various system components of the computer 1000 to the processing unit 1002. The system bus 1006 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 1000 may further include a variety of computer-readable media 1008 that includes removable/non-removable media and volatile/nonvolatile media, but excludes transitory propagated signals. Computer-readable media 1008 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computer 1000. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, radio frequency (RF), infrared, and/or other wireless media, or some combination thereof. Computer-readable media may be embodied as a computer program product, such as software stored on computer storage media.

The data storage 1004 includes computer storage media in the form of volatile/nonvolatile memory such as read only memory (ROM) and random access memory (RAM). A basic input/output system (BIOS), containing the basic routines that help to transfer information between elements within the computer 1000 (e.g., during start-up) is typically stored in ROM. RAM typically contains data and/or program modules that are immediately accessible to and/or presently being operated on by processing unit 1002. For example, in one embodiment, data storage 1004 holds an operating system, application programs, and other program modules and program data.

Data storage 1004 may also include other removable/non-removable, volatile/nonvolatile computer storage media. For example, data storage 1004 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media, described above and illustrated in FIG. 10, provide storage of computer-readable instructions, data structures, program modules and other data for the computer 1000.

A user may enter commands and information through a user interface 1010 or other input devices such as a tablet, electronic digitizer, a microphone, keyboard, and/or pointing device, commonly referred to as mouse, trackball, or touch pad. Other input devices may include a joystick, game pad, satellite dish, scanner, or the like. Additionally, voice inputs, gesture inputs (e.g., via hands or fingers), or other natural user interfaces may also be used with the appropriate input devices, such as a microphone, camera, tablet, touch pad, glove, or other sensor. These and other input devices are often connected to the processing unit 1002 through a user interface 1010 that is coupled to the system bus 1006, but may be connected by other interface and bus structures, such as a parallel port, game port or a universal serial bus (USB). A monitor 1012 or other type of display device is also connected to the system bus 1006 via an interface, such as a video interface. The monitor 1012 may also be integrated with a touch-screen panel or the like.

The computer 1000 may operate in a networked or cloud-computing environment using logical connections of a network interface or adapter 1014 to one or more remote devices, such as a remote computer. The remote computer may be a personal computer, a server, a router, a network PC, a peer device or other common network node, and typically includes many or all of the elements described above relative to the computer 1000. The logical connections depicted in FIG. 10 may include one or more local area networks (LAN), one or more wide area networks (WAN) and/or other networks, and combinations thereof. Such networking environments are commonplace in offices, enterprise-wide computer networks, intranets and the Internet.

When used in a networked or cloud-computing environment, the computer 1000 may be connected to a public and/or private network through the network interface or adapter 1014. In such embodiments, a modem or other means for establishing communications over the network is connected to the system bus 1006 via the network interface or adapter 1014 or other appropriate mechanism. A wireless networking component including an interface and antenna may be coupled through a suitable device such as an access point or peer computer to a network. In a networked environment, program modules depicted relative to the computer 1000, or portions thereof, may be stored in the remote memory storage device.

### METHODS OF USE

In some embodiments, the systems and methods described herein are useful for detecting and quantifying target analytes and biomarkers present in a fluid sample, such as a biological or non-biological fluid sample. Suitable biological samples include but are not limited to blood, tissue, urine, sputum, vaginal secretions, anal secretions, oral secretions, penile secretions, saliva, and other bodily fluids. In other embodiments, the fluid sample may be a non-biological fluid, and the disclosed microfluidic device is useful for detecting and quantifying target analytes (e.g., chemical or biological contaminants) present therein. The fluid sample may be processed or unprocessed. Processing can include filtration, centrifugation, pre-treatment by reagents, etc. For example, a biological blood sample may be filtered to remove a component of the sample (e.g., whole blood may be filtered to remove red blood cells). A biological sample (e.g., tissue cells) or non-biological sample (e.g., soil) may also be mixed with a solution (e.g., distilled water or buffer) to form a fluid prior to depositing the sample onto the microfluidic device.

Non-limiting examples of target analytes that may be detected using the disclosed technology include antibodies, proteins (e.g., glycoprotein, lipoprotein, recombinant protein, etc.), polynucleotides (e.g., DNA, RNA, oligonucleotides, aptamers, DNAzymes, etc.), lipids, polysaccharides, hormones, prohormones, narcotics, small molecule pharmaceuticals, pathogens (e.g., bacteria, viruses, fungi, protozoa). In some embodiments, the target analyte includes one or more of: aspartate transaminase (AST), alkaline phosphatase (ALP), alanine aminotransferase (ALT), bilirubin, albumin, total serum protein, glucose, cholesterol, creatine, sodium, calcium, gamma glutamyl transferase (GGT), direct bilirubin, indirect bilirubin, unconjugated bilirubin, and lactate dehydrogenase (LDH). In some embodiments, the target analyte includes one or more components of a basic metabolic panel indicative of the medical status of the patient—e.g., glucose, blood urea nitrogen, calcium, bicarbonate, chloride, creatinine, potassium, and sodium. In some embodiments, the target analyte may be a chemical or biological contaminant, such as nitrogen, bleach, salts, pesticides, metals, toxins produced by bacteria, etc.

Non-limiting examples of suitable diagnostic assays include one or more of the following reactions: redox reactions, isothermal amplification, molecular diagnostics, immunoassays (e.g., ELISA), and colorimetric assays. In some embodiments, a diagnostic chamber may remain inactive so that no reaction occurs with the sample—e.g., as a control. The diagnostic assays can provide information for determining the presence and quantity of a variety of target analytes. For instance, diagnostic assays performed on a biological fluid sample may provide information indicative of corresponding conditions such as, but not limited to, liver function, kidney function, homeostasis, metabolic function, infectious diseases, cell counts, bacterial counts, viral counts, and cancers. By providing a plurality of diagnostic assays in a single device, one fluid sample can be simultaneously subjected to a plurality of independent assay reactions that provide an informative landscape of data directed to multiple conditions of interest. In some embodiments, all of the diagnostic assays may be directed to a single condition of interest (e.g., liver disease, diabetes, contaminant levels etc.). In other embodiments, the diagnostic assays may be selected to provide a multifaceted profile of a patient (e.g., glucose levels, electrolyte levels, kidney function, liver function, etc.) or the tested fluid itself (e.g., contamination levels in a soil or water solution).

During a diagnostic assay, certain diagnostic component(s) in a sample fluid will selectively associate with a corresponding target analyte. As used herein, “selectively associates” refers to a binding reaction that is determinative for a target analyte in a heterogeneous population of other similar compounds. For example, the diagnostic component may be an antibody or antibody fragment that specifically binds to a target antigen. Non-limiting examples of suitable diagnostic components include 5-bromo-4-chloro-3-indolyl phosphate (BCIP), alpha-ketoglutarate, glucose oxidase, horseradish peroxidase, cholesterol oxidase, hydroperoxide, diisopropylbenzene dihydroperoxide, an apolipoprotein B species, 8-quinolinol, or monoethanolamine, 2,4-suraniline, 2,6-dichlorobenzene-diazonium-tetrafluoroborate, bis (3′,3″-diiodo-4′,4″-dihydroxy-5′,5″-dinitrophenyl)-3,4,5,6-tetrabromosulfonephtalein (DIDNTB), a phenolphthalein anionic dye, nitro blue tetrazolium (NBT), methyl green, rhodamine B, 3,3′,5,5′-tetramethylbenzidine, a diaphorase, methylthymol blue, a diazonium salt, and oxalacetic acid.

In some embodiments, the diagnostic component(s) include a visual indicator that exhibits a colorimetric and/or fluorometric response in the presence of a target analyte. For example, such visual indicators may become colored in the presence of the analyte, change color in the presence of the analyte, or emit fluorescence, phosphorescence, or luminescence in the presence of the analyte, or a combination thereof.

For example, an image of the reacted diagnostic region may be captured and/or analyzed according to applications described above. Those results may be electronically and securely stored within the application with respect to the fluid sample source and its identifying information.

### EXAMPLES

The present invention is next described by means of the following examples. The use of these and other examples anywhere in the specification is illustrative only, and in no way limits the scope and meaning of the invention or of any exemplified form. Likewise, the invention is not limited to any particular preferred embodiments described herein. Indeed, modifications and variations of the invention may be apparent to those skilled in the art upon reading this specification, and can be made without departing from its spirit and scope. The invention is therefore to be limited only by the terms of the claims, along with the full scope of equivalents to which the claims are entitled.

### Example 1: Microfluidic Device and Image Processing for Quantification of Albumin

This example relates to the use of a paper-based microfluidic device of the present disclosure to quantify albumin concentration in a biological sample using image processing and machine learning technology discussed above. Human serum albumin (HAS) is the most abundant protein in plasma. Quantitative determination of albumin is employed in clinical examinations. Albumin concentrations are used as an indicator of malnutrition and impaired hepatic function. The biochemical assays (developed using experimental design methods discussed above) are deposited in absorbent paper pads that act as reaction zones when the biological sample is added. A mobile device is used to capture images of the colorimetric changes on the pad and converts them into quantitative values of the albumin. The range of albumin concentration that can be quantified using the methods of this disclosure is from about 0.3 g/dL to about 7.0 g/dL. The amount of biological sample required to perform the quantitative analysis is about 30 μl of whole blood or about 10 μl of plasma. The results confirm that the microfluidic device can be used as an inexpensive alternative to conventional albumin testing. With its level of precision, ease-of-use, long shelf-life, and the short turnaround time, it provides significant value in POC and clinical settings.

In this example, the microfluidic device detects albumin using a reagent comprising bromocresol green (0.04% solution) and citrate buffer (pH4) stabilized on high purity alpha cotton linter absorbent filter paper. A colorimetric color gradient is produced where the intensity of color increases with increasing concentration of albumin in the biological sample. The images of the diagnostic test may be analyzed in accordance with this disclosure to predict a concentration of albumin in the sample being tested.

### Example 2: Microfluidic Device and Image Processing for Quantification of Aspartate Transaminase (AST)

This example relates to the use of a paper-based microfluidic device of the present disclosure to quantify AST concentration in a biological sample using image processing and machine learning technology discussed above. Quantitative determination of AST is employed in clinical examinations. AST concentrations are used as an indicator impaired hepatic function or muscle damage. The biochemical assays (developed using experimental design methods discussed above) are deposited in absorbent paper pads that act as reaction zones when the biological sample is added. A mobile device is used to capture images of the colorimetric changes on the pad and converts them into quantitative values of the AST. The range of AST concentration that can be quantified using the methods of this disclosure is from about 20 μg/L to about 400 μg/L. The amount of biological sample required to perform the quantitative analysis is about 30 μl of whole blood or about 10 μl of plasma. The results confirm that the microfluidic device can be used as an inexpensive alternative to conventional AST testing. With its level of precision, ease-of-use, long shelf-life, and the short turnaround time, it provides significant value in POC and clinical settings.

In this example, the microfluidic device detects AST using a reagent comprising Cysteine sulfinic acid (CSA) and methyl green stabilized on a suitable paper pad. The novelty is in the ability to hold these specific reagents on the pad and stabilize it at room temperature in addition to providing rapid quantitative results. A colorimetric color gradient (purple) is produced when methyl green is sulfonated to reveal Rhodamine B, where the intensity of color increases with increasing concentration of AST in the biological sample. The images of the diagnostic test may be analyzed in accordance with this disclosure to predict a concentration of AST in the sample being tested.

### Example 3: Microfluidic Device and Image Processing for Quantification of Alanine Transaminase (ALT)

This example relates to the use of a paper-based microfluidic device of the present disclosure to quantify ALT concentration in a biological sample using image processing and machine learning technology discussed above. Quantitative determination of ALT is employed in clinical examinations. ALT concentrations are used as an indicator impaired hepatic function or other diseases. The biochemical assays (developed using experimental design methods discussed above) are deposited in absorbent paper pads that act as reaction zones when the biological sample is added. A mobile device is used to capture images of the colorimetric changes on the pad and converts them into quantitative values of the ALT. The range of ALT concentration that can be quantified using the methods of this disclosure is from about 20 IU/L to about 400 IU/L. The amount of biological sample required to perform the quantitative analysis is about 50-100 μl of whole blood or about 20-40 μl of plasma. The results confirm that the microfluidic device can be used as an inexpensive alternative to conventional ALT testing. With its level of precision, ease-of-use, long shelf-life, and the short turnaround time, it provides significant value in POC and clinical settings.

In this example, the microfluidic device detects ALT using a reagent stabilized on a suitable paper pad. The novelty is in the ability to hold these specific reagents on the pad and stabilize it at room temperature in addition to providing rapid quantitative results. A colorimetric color gradient (violet) is produced, where the intensity of color increases with increasing concentration of ALT in the biological sample. The images of the diagnostic test may be analyzed in accordance with this disclosure to predict a concentration of ALT in the sample being tested.

### Example 4: Microfluidic Device and Image Processing for Quantification of Alkaline Phosphatase (ALP)

This example relates to the use of a paper-based microfluidic device of the present disclosure to quantify ALP concentration in a biological sample using image processing and machine learning technology discussed above. Quantitative determination of ALP is employed in clinical examinations. ALP concentrations are used as an indicator impaired hepatic function or other diseases. The biochemical assays (developed using experimental design methods discussed above) are deposited in absorbent paper pads that act as reaction zones when the biological sample is added. A mobile device is used to capture images of the colorimetric changes on the pad and converts them into quantitative values of the ALP. The range of ALP concentration that can be quantified using the methods of this disclosure is from about 0 μg/L to about 5000 μg/L. The amount of biological sample required to perform the quantitative analysis is about 30 μl of whole blood or about 10 μl of plasma. The results confirm that the microfluidic device can be used as an inexpensive alternative to conventional ALP testing. With its level of precision, ease-of-use, long shelf-life, and the short turnaround time, it provides significant value in POC and clinical settings.

In this example, the microfluidic device detects ALP using a reagent comprising p-Nitrophenyl Phosphate and Disodium Salt stabilized on a blott card. The novelty is in the ability to hold these specific reagents on the pad and stabilize it at room temperature in addition to providing rapid quantitative results. A colorimetric color gradient (yellow) is produced, where the intensity of color increases with increasing concentration of ALP in the biological sample. The images of the diagnostic test may be analyzed in accordance with this disclosure to predict a concentration of ALP in the sample being tested.

### Example 5: Microfluidic Device and Image Processing for Quantification of Blood Urea Nitrogen (BUN)

This example relates to the use of a paper-based microfluidic device of the present disclosure to quantify BUN concentration in a biological sample using image processing and machine learning technology discussed above. Quantitative determination of BUN is employed in clinical examinations. BUN concentrations are used as an indicator impaired hepatic function or other diseases. The biochemical assays (developed using experimental design methods discussed above) are deposited in absorbent paper pads that act as reaction zones when the biological sample is added. A mobile device is used to capture images of the colorimetric changes on the pad and converts them into quantitative values of the BUN. The range of BUN concentration that can be quantified using the methods of this disclosure is from about 0 mg/dL to about 200 mg/dL. The amount of biological sample required to perform the quantitative analysis is about 30 μl of whole blood or about 10 μl of plasma. The results confirm that the microfluidic device can be used as an inexpensive alternative to conventional BUN testing. With its level of precision, ease-of-use, long shelf-life, and the short turnaround time, it provides significant value in POC and clinical settings.

In this example, the microfluidic device detects BUN using a reagent comprising Jung reagent with Primaquine bisphosphate and Sodium dodecyl sulfate (SDS) stabilized on cellulose paper. The novelty is in the ability to hold these specific reagents on the pad and stabilize it at room temperature in addition to providing rapid quantitative results. A colorimetric color gradient is produced, where the intensity of color increases with increasing concentration of BUN in the biological sample. The images of the diagnostic test may be analyzed in accordance with this disclosure to predict a concentration of BUN in the sample being tested.

### Example 6: Microfluidic Device and Image Processing for Quantification of Creatinine

This example relates to the use of a paper-based microfluidic device of the present disclosure to quantify creatinine concentration in a biological sample using image processing and machine learning technology discussed above. Quantitative determination of creatinine is employed in clinical examinations. creatinine concentrations are used as an indicator impaired hepatic function or other diseases. The biochemical assays (developed using experimental design methods discussed above) are deposited in absorbent paper pads that act as reaction zones when the biological sample is added. A mobile device is used to capture images of the colorimetric changes on the pad and converts them into quantitative values of the creatinine. The range of creatinine concentration that can be quantified using the methods of this disclosure is from about 0.5 mg/dL to about 20 mg/dL. The amount of biological sample required to perform the quantitative analysis is about 30 μl of whole blood or about 10 μl of plasma. The results confirm that the microfluidic device can be used as an inexpensive alternative to conventional creatinine testing. With its level of precision, ease-of-use, long shelf-life, and the short turnaround time, it provides significant value in POC and clinical settings.

In this example, the microfluidic device detects creatinine using a reagent comprising sodium picrate (Jaffe reagent (with increased Sodium dodecyl sulfate)) stabilized on Whatman 3 paper. The novelty is in the ability to hold these specific reagents on the pad and stabilize it at room temperature in addition to providing rapid quantitative results. A colorimetric color gradient is produced, where the intensity of color increases with increasing concentration of creatinine in the biological sample. The images of the diagnostic test may be analyzed in accordance with this disclosure to predict a concentration of creatinine in the sample being tested.

### Example 7: Microfluidic Device and Image Processing for Quantification of Total Protein

This example relates to the use of a paper-based microfluidic device of the present disclosure to quantify total protein concentration in a biological sample using image processing and machine learning technology discussed above. Quantitative determination of total protein is employed in clinical examinations. Total protein concentrations are used as an indicator of impaired hepatic function or other diseases. The biochemical assays (developed using experimental design methods discussed above) are deposited in absorbent paper pads that act as reaction zones when the biological sample is added. A mobile device is used to capture images of the colorimetric changes on the pad and converts them into quantitative values of the total protein. The range of total protein concentration that can be quantified using the methods of this disclosure is from about 0 g/dL to about 15 g/dL. The amount of biological sample required to perform the quantitative analysis is about 30 μl of whole blood or about 10 μl of plasma. The results confirm that the microfluidic device can be used as an inexpensive alternative to conventional total protein testing. With its level of precision, ease-of-use, long shelf-life, and the short turnaround time, it provides significant value in POC and clinical settings.

In this example, the microfluidic device detects total protein using a reagent comprising biuret total protein reagent stabilized on high purity alpha cotton linter absorbent filter paper. The novelty is in the ability to hold these specific reagents on the pad and stabilize it at room temperature in addition to providing rapid quantitative results. A colorimetric color gradient is produced, where the intensity of color increases with increasing concentration of total protein in the biological sample. The images of the diagnostic test may be analyzed in accordance with this disclosure to predict a concentration of total protein in the sample being tested.

### Example 8: Microfluidic Device and Image Processing for Quantification of Hematocrit

This example relates to the use of a paper-based microfluidic device of the present disclosure for whole blood separation, and quantification of hematocrit concentration in a biological sample using image processing and machine learning technology discussed above (using the same device). Quantitative determination of hematocrit is employed in clinical examinations. Hematocrit concentrations are used as an indicator of impaired hepatic function or other diseases. The biochemical assays (developed using experimental design methods discussed above) are deposited in absorbent paper pads that act as reaction zones when the biological sample is added. A mobile device is used to capture images of the colorimetric changes on the pad and converts them into quantitative values of the hematocrit. The range of hematocrit concentration that can be quantified using the methods of this disclosure is from about 15 to 70% The amount of biological sample required to perform the quantitative analysis is about 30 μl of whole blood or about 10 μl of plasma. The results confirm that the microfluidic device can be used as an inexpensive alternative to conventional hematocrit testing. With its level of precision, ease-of-use, long shelf-life, and the short turnaround time, it provides significant value in POC and clinical settings.

In this example, the microfluidic device detects hematocrit stabilized on a combination of the two adhered layers compressed in a rastered plastic material (e.g., a laminate). The novelty is in the combination of a top plasma-separation membrane and a bottom chemical reaction pad, the two stacked using a non-reactive adhesive in the perimeter and embedded within a plastic apparatus for additional pressure-driven plasma separation to allow for whole blood separation and hematocrit quantification using the same platform. Further novelty lies in the ability to hold reagents for quantitative colorimetric analysis on the pad and stabilize it at room temperature in addition to providing rapid quantitative results. A colorimetric color gradient is produced, where the intensity of color increases with increasing concentration of hematocrit in the biological sample. The images of the diagnostic test may be analyzed in accordance with this disclosure to predict a concentration of hematocrit in the sample being tested.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

In this document, when relative terms of order such as “first” and “second” are used to modify a noun, such use is simply intended to distinguish one item from another, and is not intended to require a sequential order unless specifically stated. In addition, terms of relative position such as “front” and “rear”, or “ahead” and “behind”, when used, are intended to be relative to each other and need not be absolute, and only refer to one possible position of the device associated with those terms depending on the device's orientation.

While this disclosure describes example embodiments for example fields and applications, it should be understood that the disclosure is not limited to the disclosed examples. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described in this document. Further, embodiments (whether or not explicitly described) have significant utility to fields and applications beyond the examples described in this document.

Embodiments have been described in this document with the aid of functional building blocks illustrating the implementation of specified functions and relationships. The boundaries of these functional building blocks have been arbitrarily defined in this document for the convenience of the description. Alternate boundaries can be defined as long as the specified functions and relationships (or their equivalents) are appropriately performed. Also, alternative embodiments can perform functional blocks, steps, operations, methods, etc. using orderings different than those described in this document.

The features from different embodiments disclosed herein may be freely combined. For example, one or more features from a method embodiment may be combined with any of the system or product embodiments. Similarly, features from a system or product embodiment may be combined with any of the method embodiments herein disclosed.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents.

All publications cited and/or discussed in this specification are incorporated herein by reference in their entireties and to the same extent as if each reference was individually incorporated by reference.

1. A paper based microfluidic diagnostic device, comprising:
a top panel comprising a first plurality of cut regions; and
a bottom panel comprising a second plurality of cut regions, wherein:
the first and second plurality of cut regions are configured to form a plurality of diagnostic wells,
each of the plurality of diagnostic wells comprises a diagnostic paper layer positioned over a filter paper layer,
the diagnostic paper layer comprises one or more diagnostic components for quantitative assessment of an analyte, and
at least one of the top panel or the bottom panel comprises a plurality of image registration markers and a plurality of image calibration markers.

2. The paper based microfluidic diagnostic device of claim 1, wherein each of the plurality of diagnostic wells is configured to receive a fluid sample from a side of the bottom panel such that the fluid sample flows vertically to the diagnostic paper layer via the filter paper layer.

3. The paper based microfluidic diagnostic device of claim 1, wherein the diagnostic paper is a single layer sheet of hydrophilic porous paper.

4. (canceled)

5. The paper based microfluidic diagnostic device of claim 1, wherein the one or more diagnostic components are selected from reagents, dyes,
probes, stabilizers, catalysts, anti-coagulants, lysing agents, nanoparticles, diluents, and
combinations thereof.

6. The paper based microfluidic diagnostic device of claim 1, wherein at least one diagnostic component is capable of selectively associating with the analyte selected from aspartate transaminase, alkaline phosphatase, alanine aminotransferase, bilirubin, albumin, total serum protein, glucose, cholesterol, creatine, sodium, calcium, gamma glutamyl transferase, direct bilirubin, indirect bilirubin, unconjugated bilirubin, and lactate dehydrogenase, glucose, blood urea nitrogen, calcium, bicarbonate, chloride, creatinine, potassium, hematocrit and sodium.

7. The paper based microfluidic diagnostic device of claim 1, further comprising an identifying marker.

8. The paper based microfluidic diagnostic device of claim 7, wherein the identifying marker comprises a QR code or barcode.

9. The paper based microfluidic diagnostic device of claim 1, wherein each of the plurality of image registration markers comprise an ArUco marker.

10. (canceled)

11. The paper based microfluidic diagnostic device of claim 1, wherein the plurality of image calibration markers comprise a plurality of reference color markers.

12. The paper based microfluidic diagnostic device of claim 11, wherein the plurality of image calibration markers comprise 24 unique colors.

13. The paper based microfluidic diagnostic device of claim 12, each of the 24 unique colors are included in at least two of the plurality of image calibration markers.

14. (canceled)

15. The paper based microfluidic diagnostic device of claim 1, further comprising at least one slot for receiving a lateral flow reaction substrate.

16. A method of detecting and quantifying a target analyte in a fluid sample, comprising the steps of:
(a) obtaining a fluid sample;
(b) depositing the fluid sample onto a microfluidic diagnostic device comprising one or more diagnostic wells that each comprise: (i) a diagnostic paper layer that includes one or more diagnostic components provided thereon, and (ii) a filter paper later;
(c) capturing, using an image capture device, an image of a reacted microfluidic diagnostic device;
(d) identifying, based on image registration markers included in the image, a region corresponding to a reacted diagnostic well of the microfluidic diagnostic device;
(e) normalizing, based on image calibration markers included in the image, a color of the region corresponding to the reacted diagnostic well to generate a normalized color; and
(f) analyzing, using a machine learning model, the normalized color to predict a diagnostic test result.

17. (canceled)

18. The method of claim 16, wherein identifying the region corresponding to the reacted diagnostic well comprises:
identifying, in the image, one or more image registration markers;
determining, based on the image registration markers, a pose of the image capture device;
using the pose of the image capture device to align the image with a template image corresponding to the diagnostic device; and
identifying the region corresponding to the reacted diagnostic well based on a location of a diagnostic well in the template image.

19. The method of claim 18, further comprising identifying the template image corresponding to the diagnostic device based on an identification marker included in the image.

20. (canceled)

21. The method of claim 16, wherein normalizing the color of the region corresponding to the reacted diagnostic well comprises performing a masking operation and a color transformation.

22. The method of claim 21, wherein performing the color transformation comprises performing white balancing of the image.

23. The method of claim 22, wherein performing the white balancing of the image comprises comparing an observed color value of a white colored image calibration marker to a known color value of the white colored image calibration marker.

24. The method of claim 21, wherein performing the color transformation comprises generating a global transformation function for transforming the image to a first normalized image.

25. (canceled)

26. The method of claim 24, further comprising reducing a dimensionality of the first normalized image to generate a reduced dimensionality image.

27. (canceled)

28. (canceled)

29. The method of claim 21, further comprising performing the masking operation before performing the color transformation, the masking operation comprising masking the region corresponding to the reacted diagnostic well.

30. The method of claim 16, further comprising identifying the machine learning model based on an identification marker included in the image.

31.-48. (canceled)

49. A microfluidic diagnostic device, comprising:
a top panel comprising a first plurality of cut regions; and
a bottom panel comprising a second plurality of cut regions, wherein:
the first and second plurality of cut regions are configured to form a plurality of receptacles that are each configured to receive a lateral flow test strip, and
at least one of the top panel or the bottom panel comprises a plurality of image registration markers included on the top panel and a plurality of image calibration markers.

50. (canceled)
